(19) United States
(12) Patent Application Publication
(10) Pub. No.: US 2026/0065385 A1
(43) Pub. Date: Mar. 5, 2026

(54) VEHICLE FUEL UTILIZATION MANAGEMENT PLATFORM

(71) Applicant: ONRAMP PAYMENTS, INC., Vergennes, VT (US)

(72) Inventors: Jeremie Myhren, Roscoe, IL (US); Michael Morris, Vergennes, VT (US); Austin Mayberry, Louisville, KY (US); Jesse Wallace, Sacramento, CA (US); Daniel Rohtbart, Vergennes, VT (US)

(21) Appl. No.: 19/313,666

(22) Filed: Aug. 28, 2025

Related U.S. Application Data
(60) Provisional application No. 63/688,754, filed on Aug. 29, 2024.

(51) Int. Cl. G06Q 50/06; G06Q 20/20; G06Q 20/38; G06Q 20/40; G06Q 30/0283; G07C 5/00; G07C 5/02; G07F 13/02

(52) U.S. Cl. CPC G06Q 50/06; G06Q 20/206; G06Q 20/3821; G06Q 20/4016; G06Q 30/0283; G07C 5/008; G07C 5/02; G07F 13/025

(57) ABSTRACT

A fuel utilization management system is disclosed. The fuel utilization management system comprises at least one processor communicatively coupled with a memory. The at least one processor is configured to receive automatically a fueling request in real time; determine a geographic location of a vehicle; generate a list of fuel dispensing units for fueling the vehicle; send the generated list of the fuel dispensing units to a user; receive a selection of a fuel dispensing unit; generate automatically a secure fueling token associated with the selected fuel dispensing unit, for the user; validate the secure fueling token entered by the user in the selected fuel dispensing unit matches with the vehicle associated with the user; determine whether an amount of fuel dispensed by the selected fuel dispensing unit is equal to an amount of the fuel received by the vehicle; determine discrepancies; and terminate the fueling of the vehicle.

### TECHNOLOGICAL FIELD

The present invention relates to a fuel management, and more particularly relates to a fuel utilization management system for vehicles and a method thereof.

### BACKGROUND

Commercial vehicle drivers frequently rely on conventional point-of-sale interfaces at fuel stations to initiate and complete fueling transactions. However, conventional approach introduces various challenges, particularly with respect to transaction security, location-based authorization, user verification, and operational efficiency. Traditional systems often lack seamless integration between the driver's fueling request and the fuel dispenser, leading to delays, miscommunication, or even fraudulent activity. Additionally, manual entry of pump numbers or driver IDs at unattended or third-party stations increases the likelihood of errors and unauthorized use. There is also limited transparency in real-time transaction status, making it difficult for fleet operators to monitor or reconcile fuel usage accurately. The challenges create inefficiencies, increase operational risk, and hinder effective transaction control across decentralized fueling networks.

Further, many methods and devices have been used unsuccessfully attempting to efficiently and effectively provide simple and easy to use systems to monitor fuel being dispensed to specific vehicles across a plurality of locations in a near real time fashion. Traditional fueling payment systems typically perform a two-stage transaction process, involving initial authorization and finalization upon completion. However, these systems lack real-time interaction and oversight capabilities, limiting their ability to handle operational issues such as fraud, discrepancies, or inefficiencies. Several devices, systems and workaround methods have been created unsuccessfully to address the problem of needing to have attendant interaction to have supervisory capabilities of multiple vehicles fueling at various locations, simultaneously.

Moreover, multiple personnel and a variety of different platforms and systems are needed in order to provide oversight of multiple vehicles obtaining fuel at a variety of locations and to be able to authenticate actual delivery to specific vehicles. Current systems and devices do not allow for an easy, effective, and efficient manner of rapidly and efficiently monitoring the plurality of vehicle fueling evolutions in order to prevent fraudulent fuel dispensing. Accordingly, there is an established need for vehicle fuel utilization management platforms which solve at least one of the aforementioned problems. Further, there is an established need for integrated fuel vehicle utilization platforms and systems for monitoring in real time multiple fuel transfer evolutions at a variety of locations in order to prevent fraud.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a fuel utilization management system is disclosed. The fuel utilization management system comprises a memory having one or more computer readable instructions. The fuel utilization management system further comprises at least one processor communicatively coupled with the memory. The at least one processor executing the one or more computer readable instructions stored in the memory is configured to receive, from a request source, automatically a fueling request in real time. The fueling request corresponds to a request from the request source for fueling the vehicle. The at least one processor is configured to determine a geographic location of the vehicle upon receiving the fueling request from the request source. The at least one processor is further configured to generate a list of one or more fuel dispensing units for fueling the vehicle, based at least on the determined geographic location of the vehicle. The at least one processor is further configured to send the generated list of the one or more fuel dispensing units to a user. The at least one processor is further configured to receive a selection of a fuel dispensing unit from the generated list of the one or more fuel dispensing units, from the user. Further, the at least one processor is configured to generate automatically a secure fueling token associated with the selected fuel dispensing unit, for the user. The at least one processor is further configured to validate the secure fueling token entered by the user in the selected fuel dispensing unit matches with the vehicle associated with the user, for fueling of the vehicle. The at least one processor is further configured to determine, during the fueling of the vehicle, whether an amount of fuel dispensed by the selected fuel dispensing unit is equal to an amount of the fuel received by the vehicle, based at least on a plurality of parameters associated with the selected fuel dispensing unit and a plurality of parameters associated with the vehicle. The at least one processor is further configured to determine one or more discrepancies during the fueling of the vehicle upon determining the amount of fuel dispensed by the selected fuel dispensing unit is not equal to the amount of the fuel received by the vehicle. Thereafter, the at least one processor is configured to terminate the fueling of the vehicle upon determining the one or more discrepancies.

In some embodiments, the request source comprises at least the vehicle associated with a company or the user responsible for paying for the fueling, a computing device associated with the user or the company, or a computing device of the vehicle.

In some embodiments, at least one processor executing the one or more computer readable instructions stored in the memory is configured to dynamically repricing a unit price of fuel upon receiving the fueling request from the request source, based at least on a current retail price, a negotiated agreement between a fuel carrier and a merchant, a negotiated agreement between a fuel program and the merchant, a negotiated agreement between the carrier and the fuel program, or a schedule of fees; and generate in real time, receipt data from the selected fuel dispensing unit based at least on the repricing of the unit price and upon determining the amount of fuel dispensed by the selected fuel dispensing unit is equal to the amount of the fuel received by the vehicle; and transmit the receipt data to the computing device to initiate digital payment, upon fueling of the vehicle.

In some embodiments, the at least one processor executing the one or more computer readable instructions stored in the memory is configured to validate, prior to determine the current geographic location of the vehicle and generate the secure fueling token, that the fueling request is not fraudulent, based on historical information of the request source, wherein the historical information includes at least purchase history and location history; and preauthorize a purchasing power of the secure fueling token, based on the historical information, business rules specified by the user associated with the vehicle, and business rules specified by the fuel program.

In some embodiments, the at least one processor executing the one or more computer readable instructions stored in the memory is configured to transmit the secure fueling token directly to at least one of a point-of-sale (POS) system associated with the selected fuel dispensing unit, or a forecourt control interface associated with the selected fuel dispensing unit, for enabling fueling of the vehicle automatically. Further, the at least one processor is configured to inject the secure fueling token into at least one of the POS system or the forecourt control interface, associated with the selected fuel dispensing unit, in response to determining that the selected fuel dispensing unit does not have a direct integration with the fuel utilization management system. Thereafter, the at least one processor is configured to activate the selected fuel dispensing unit via at least one of the POS interface or the forecourt control interface, without generating the secure fueling token, to enable tokenless fueling of the vehicle.

In some embodiment, the at least one processor executing the one or more computer readable instructions stored in the memory is configured to transmit, using a secure communication link, the secure fueling token entered by the user to the forecourt control interface to validate the secure fueling token.

In some embodiments, the plurality of parameters associated with the selected fuel dispensing unit comprises at least type of fuel dispensed, the amount of fuel dispensed, price of the fuel, and rate of the fuel.

In some embodiments, the plurality of parameters associated with the vehicle comprises at least fuel type of vehicle, real time fuel level within a fuel tank of the vehicle, and capacity of the fuel tank of the vehicle.

In some embodiments, the at least one processor executing the one or more computer readable instructions stored in the memory is further configured to receive, via an image capturing unit installed within the vehicle, one or more images of the selected fuel dispensing unit captured by the image capturing unit; analyze, using an artificial intelligence (AI) vision module, the one or more images of the selected fuel dispensing unit to determine a unique identification number associated with the selected fuel dispensing unit; and compare the determined unique identification number with the selected fuel dispensing unit to confirm the selected fuel dispensing unit by the user.

In some embodiments, the at least one processor executing the one or more computer readable instructions stored in the memory is further configured to trigger a feedback alert to the user upon determining the one or more discrepancies. The one or more discrepancies comprises the vehicle moving away from the selected fuel dispensing unit determined based on the geographic location of the vehicle.

In some embodiments, the receipt data includes at least one of a quantity of fuel dispensed, total transaction cost, time of fueling, and the a unique identification number associated with the selected fuel dispensing unit, and discount price of the fuel provided to the request source.

In some embodiments, the geographic location of the vehicle is determined using at least one of GPS coordinates, Wi-Fi-based location services, or cellular triangulation.

In another example embodiment, a method is disclosed. The method comprises receiving, via at least one processor executing one or more computer readable instructions stored in a memory of a fuel utilization management system, automatically a fueling request in real time from a request source. The fueling request corresponds to a request from the request source for fueling a vehicle. The method further comprises determining, via the at least one processor, a geographic location of the vehicle upon receiving the fueling request from the request source. Further, the method comprises generating, via the at least one processor, a list of one or more fuel dispensing units for fueling the vehicle, based on at least the determined geographic location of the vehicle. Further, the method comprises sending, via the at least one processor, the generated list of the one or more fuel dispensing units to a user. Further, the method comprises receiving, via the at least one processor, a selection of a fuel dispensing unit from the generated list of the one or more fuel dispensing units, from the user. Further, the method comprises generating, via the at least one processor, automatically a secure fueling token associated with the selected fuel dispensing unit, for the user. Further, the method comprises validating, via the at least one processor, the secure fueling token entered by the user in the selected fuel dispensing unit matches with the vehicle associated with the user, for fueling of the vehicle. Further, the method comprises determining, via the at least one processor, during the fueling of the vehicle, whether an amount of fuel dispensed by the selected fuel dispensing unit is equal to an amount of the fuel received by the vehicle, based at least on a plurality of parameters associated with the selected fuel dispensing unit and a plurality of parameters associated with the vehicle. Further, the method comprises determining, via the at least one processor, one or more discrepancies during the fueling of the vehicle upon determining the amount of fuel dispensed by the selected fuel dispensing unit is not equal to the amount of the fuel received by the vehicle. Thereafter, the method comprises terminating, via the at least one processor, the fueling of the vehicle upon determining the one or more discrepancies.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a fuel utilization management system in accordance with an example embodiment of the present disclosure;

FIG. 2 illustrates a block diagram of a server in accordance with an example embodiment of the present disclosure;

FIG. 3 illustrates an example user interface flow diagram of a method for controlling a vehicle fueling transaction in accordance with an example embodiment of the present disclosure;

FIG. 4A illustrates a communication sequence between the system and a forecourt control interface in accordance with an example embodiment of the present disclosure;

FIG. 4B illustrates a block diagram illustrating fueling session pre-requisites in accordance with an example embodiment of the present disclosure;

FIG. 4C illustrates an example flow diagram illustrating a fueling session initiation process in accordance with an example embodiment of the present disclosure;

FIG. 5 illustrates a flow diagram depicting a token-based fueling transaction process in accordance with an example embodiment of the present disclosure;

FIG. 6 illustrates a transaction flow diagram in accordance with an example embodiment of the present disclosure;

FIG. 7 illustrates a sequence diagram representing a method for authorizing and executing a fueling transaction in accordance with an example embodiment of the present disclosure;

FIG. 8 illustrates an interaction diagram between a partner, a program, a merchant, and the system in accordance with an example embodiment of the present disclosure;

FIGS. 9A-9C illustrate example user interface (UI) screens of a fuel utilization management application for configuring and managing a discount program in accordance with an example embodiment of the present disclosure;

FIGS. 10A-10B illustrate exemplary user interface of a controller simulator system configured for fuel site management in accordance with example embodiments of the present disclosure; and

FIG. 11 illustrates a flowchart of a method for executing a transaction session in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a fuel utilization management system. Embodiments may be configured to receive, from a request source, automatically a fueling request in real time. The fueling request corresponds to a request from the request source for fueling a vehicle. Embodiments may be further configured to determine a geographic location of the vehicle upon receiving the fueling request from the request source. Embodiments may be configured to generate a list of one or more fuel dispensing units for fueling the vehicle, based at least on the determined geographic location of the vehicle. Embodiments may be further configured to send the generated list of the one or more fuel dispensing units to the user. Embodiments may be further configured to receive a selection of a fuel dispensing unit from the generated list of the one or more fuel dispensing units, from the user. Embodiments may be further configured to generate automatically a secure fueling token associated with the selected fuel dispensing unit, for the user.

Embodiments may be further configured to validate the secure fueling token entered by the user in the selected fuel dispensing unit matches with the vehicle associated with the user, for fueling of the vehicle. Embodiments may be further configured to determine, during the fueling of the vehicle, whether an amount of fuel dispensed by the selected fuel dispensing unit is equal to an amount of the fuel received by the vehicle, based at least on a plurality of parameters associated with the selected fuel dispensing unit and a plurality of parameters associated with the vehicle. Embodiments may be further configured to determine one or more discrepancies during the fueling of the vehicle upon determining the amount of fuel dispensed by the selected fuel dispensing unit is not equal to the amount of the fuel received by the vehicle. Embodiments may be further configured to terminate the fueling of the vehicle upon determining the one or more discrepancies.

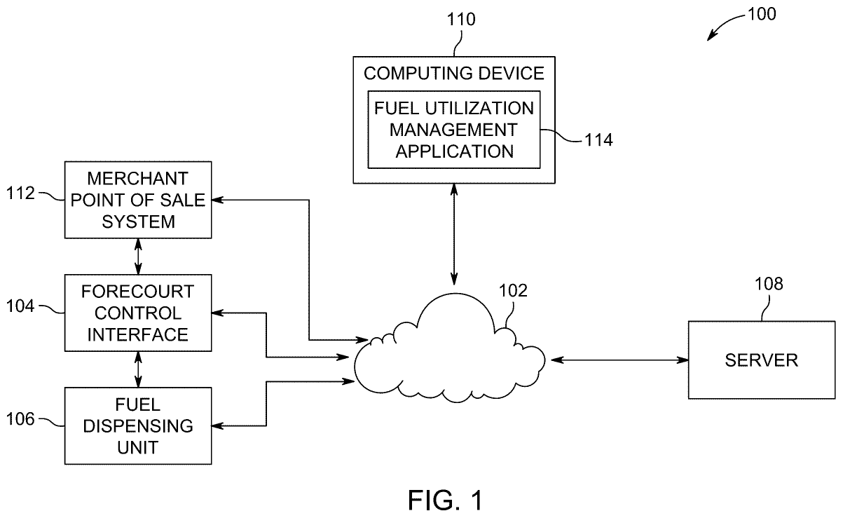

FIG. 1 illustrates a network diagram of a fuel utilization management system 100 in accordance with an example embodiment of the present disclosure. The fuel utilization management system 100 may comprise a network 102, a forecourt control interface 104, a fuel dispensing unit 106, a server 108, a computing device 110, and a merchant point of sale system 112.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), One or more travelers Datagram Protocol (UDP), and 2G, 3G, or 4G communication protocols.

In some embodiments, the fuel utilization management system 100 may be referred to as a system 100. Further, the system 100 may comprise the forecourt control interface 104. The forecourt control interface 104 may correspond to an interface module communicatively coupled with the fuel dispensing unit 106 located at a fueling station. The forecourt control interface 104 may be used at a fueling station to manage and control the operation of the fuel dispensing unit 106 and other related equipment on a forecourt (i.e., an area where fueling takes place). The forecourt control interface 104 may be configured to connect the merchant point of sale system 112 inside the fueling station with the fuel dispensing unit 106, and may allow the fueling station to start, stop, and monitor the fueling process.

In some embodiments, the fuel dispensing unit 106 may correspond to a pump or a dispenser configured to deliver fuel to a vehicle at the fueling station in response to a valid fueling authorization. In some embodiments, the fuel dispensing unit 106 is configured to deliver fuel (such as gasoline, diesel, or alternative fuels) to the vehicle. The fuel dispensing unit 106 typically includes one or more nozzles, fuel pumps, meters, valves, sensors, and display interfaces. In some embodiments, the fuel dispensing unit 106 may be electronically and communicatively coupled to the forecourt control interface 104, allowing external systems such as the fuel utilization management system 100 to control or monitor fuel delivery operations. The fuel dispensing unit 106 may also be associated with unique identifiers to enable secure token-based transactions and real-time data exchange regarding the type and quantity of fuel dispensed.

In some embodiments, the vehicle may correspond to a commercial vehicle such as a car, a bus, or a truck. The fuel dispensing unit 106 may include hardware components such as a nozzle, a metering unit, flow control valves, and user interface elements (e.g., display screen, keypad), and may be electronically controllable via the forecourt control interface 104. Upon receiving the secure fueling token from the server 108, the forecourt control interface 104 may activate the corresponding fuel dispensing unit 106 to permit fuel delivery. The fuel dispensing unit 106 may be further configured to communicate real-time dispensing parameters to the server 108. The real-time dispensing parameters may include at least one of volume of fuel dispensed, fueling duration, and pricing data.

In some embodiments, the server 108 may be a computer or software module that is configured to provide centralized resources, data, or services to the computing device 110 operated by a user. The server 108 may be configured to handle and manage one or more computational tasks and data processing within the system 100. In some embodiments, the server 108 may include storage systems, such as hard drives or storage arrays, to store and manage large volumes of data and information accessible to network users. In some embodiments, the server 108 may further provide centralized control and management capabilities, allowing network users to configure, monitor, and maintain network resources, security settings, and one or more travelers access permissions from a single location.

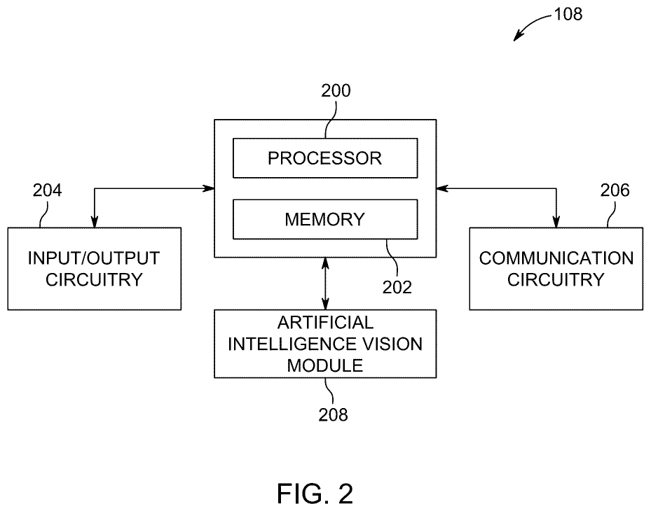

In some embodiments, the server 108 may comprise a memory and at least one processor (described in FIG. 2) communicatively coupled with the memory. The memory may have one or more computer readable instructions. The at least one processor may be communicatively coupled to the memory. In some embodiments, the server 108 may be configured to receive automatically a fueling request in real time. The fueling request may correspond to a request from a request source for fueling the vehicle. In some embodiments, the request source may comprise at least one of the vehicle associated with a company or the user responsible for paying for the fueling, a computing device associated with the user or the company, or a computing device of the vehicle. The user may correspond to an autonomous driver or a physical driver of the vehicle. The fueling request may correspond to an action initiated by the user through a mobile application or an authorized interface installed on the computing device 110. The mobile application may correspond to a fuel utilization management application 114. The fueling request may include user identification credentials. Upon receiving the fueling request, the server 108 may initiate a sequence of backend processing operations that may verify the user identification credentials, and may assess eligibility for fueling.

In some embodiment, the server 108 may be configured to validate that the fueling request is not fraudulent, based on historical information of the request source, prior to determine geographic location of the vehicle and generate a secure fueling token. The historical information includes at least purchase history and location history. Further, the server 108 may be configured to preauthorize a purchasing power of the secure fueling token, based on the historical information, business rules specified by the user associated with the vehicle, and business rules specified by the fuel program.

In some embodiments, the at least one processor 200 may be further configured to enforce fueling rules based on fleet-specific policies or preferences. The at least one processor 200 may dynamically adjust fraud detection thresholds, fueling limits, or enforcement actions based on a risk tolerance or policy settings defined by the fleet manager associated with the vehicle or user. In some embodiments, the at least one processor 200 may allow fleet-specific overrides, such that certain fueling transactions may be approved, paused, or terminated differently depending on the fleet's rules. The fleet-specific policy logic may integrate with data received from ELDs, fuel sensors, vision systems, and transaction history to determine real-time enforcement actions, ensuring that fueling operations comply with fleet-defined policies while maintaining security, accuracy, and operational efficiency.

In some embodiments, the server 108 may be configured to determine a geographic location of the vehicle upon receiving the fueling request from the request source. The geographic location of the vehicle may be determined through one or more localization methods. The one or more localization methods may include at least one of GPS coordinates, Wi-Fi-based location services, or cellular triangulation. The geographic location may be used in real time to match the user to nearby fueling stations.

In some embodiments, the server 108 may be configured to generate a list of one or more fuel dispensing units for fueling the vehicle, based on at least the determined geographic location of the vehicle. In one embodiment, the server 108 may be configured to generate the list of the one or more fuel dispensing units within a predefined proximity for fueling the vehicle, based on one or more parameters associated with the user. The one or more parameters may include at least one of a transaction history, the user credentials, vehicle information, fueling preferences, or time-of-day usage patterns. In some embodiments, the list of one or more fuel dispensing units may further be refined based on integration with the merchant point of sale system 112 to ensure the fuel dispensing units 106 with active payment or loyalty program compatibility may be prioritized. In some embodiments, the server 108 may be configured to send the generated list of the one or more fuel dispensing units to the user.

In some embodiments, the generated list of the one or more fuel dispensing units may be displayed over the fuel utilization management application 114 installed on the computing device 110 operated by the user. In some embodiments, the server 108 may be configured to receive a selection of a fuel dispensing unit 106 from the generated list of the one or more fuel dispensing units, from the user. The user may interact with the fuel utilization management application 114 to select the fuel dispensing unit 106. The selection may include identifying information such as a pump number, a location identifier (ID), or QR code corresponding to the selected fuel dispensing unit 106. The selection may also include interaction with the merchant point of sale system 112 to preauthorize payment or apply user-specific discounts prior to fueling.

In some embodiments, the server 108 may be configured to identify the fuel dispensing unit 106 associated with the vehicle using a plurality of identification modalities. The plurality of identification modalities may be performed manually or automatically. In one example, the user may interact with the fuel utilization management application 114 installed on the computing device 110 to select a specific fuel dispensing unit 106 from the list of the one or more fuel dispensing units. The selection may include identifying information such as a fuel dispensing unit number, the location ID, or the QR code corresponding to the selected fuel dispensing unit 106.

In some embodiments, the server 108 may be configured to receive, via an image capturing unit installed within the vehicle, one or more images of the selected fuel dispensing unit 106 captured by the image capturing unit. The image capturing unit may correspond to a camera. The image capturing unit may visually identify which fuel dispensing unit the vehicle is parked near. In some embodiments, the server 108 may be configured to analyze, using an artificial intelligence (AI) vision module (shown in FIG. 2), the one or more images of the fuel dispensing unit 106 to determine a unique identification number associated with the selected fuel dispensing unit 106. The unique identification number may correspond to a unique label or a unique code displayed on the fuel dispensing unit 106. In an alternate embodiment, the server 108 may be configured to analyze AI based verification of the vehicle (for example, a truck) to determine a driver identity, using the AI vision module. In some embodiments, fuel level or usage inference may be extracted from video or electronic logging device (ELD) data.

In some embodiments, the server 108 may be further configured to compare the determined unique identification number with the selected fuel dispensing unit 106 to confirm the selected fuel dispensing unit 106 by the user. The comparison may help confirm whether the user has correctly selected the same fuel dispensing unit 106 that the vehicle is actually located next to. In an alternate embodiment, the server 108 may be configured to compare the determined driver identity with the ELD data to confirm whether the fuel dispensing unit 106 is selected by the correct user.

Further, the server 108 may further be configured to determine a fueling position of the vehicle using the captured one or more images. In some embodiments, the server 108 may determine if the user has parked the vehicle in the fueling position which is correct for refueling the vehicle from the selected fuel dispensing unit 106. Further, the server 108 may also be configured to determine if the user has parked the vehicle in the fueling position for more a threshold time period. The vehicle parked for more than the threshold time period indicates that the vehicle is ready to be fueled.

In some embodiments, the server 108 may be configured to automatically determine the fuel dispensing unit 106 without user input using a combination of the geographic location data, such as GPS coordinates, Wi-Fi triangulation, or cellular network triangulation, to determine which fuel dispensing unit 106 the vehicle is adjacent to. In some embodiments, the server 108 may also implement proximity-based detection or vision-based detection methods to enhance or replace manual selection. In one example, the image capturing unit may be configured to capture the one or more images of fueling area. The server 108 may analyze the one or more images using the AI vision module to detect a unique pump number, a visual label, or a code displayed on the fuel dispensing unit 106. In another example, the server 108 may utilize the proximity-based detection methods, such as Bluetooth or RFID to identify the closest fuel dispensing unit 106 to the vehicle. In some embodiments, two or more identification modalities may be combined to verify the selection of the fuel dispensing unit 106 before initiating fueling transaction.

In some embodiments, the server 108 may be configured to generate automatically a secure fueling token associated with the selected fuel dispensing unit 106, for the user. The secure fueling token may be digitally linked to the fuel dispensing unit 106 that the user has selected. The secure fueling token may act like a temporary, unique permission slip that may allow the selected fuel dispensing unit 106 to be activated for fueling. The secure fueling token may be a time-bound, cryptographically generated identifier that may uniquely link a user session to the selected fuel dispensing unit 106. The secure fueling token may include encoded metadata such as user ID, dispenser ID, fuel product selection, authorization parameters, and token expiration time. The secure fueling token may serve as a digital key to enable fuel delivery and prevent unauthorized access or spoofing attempts.

In some embodiments, the server 108 may further be configured to validate the secure fueling token entered by the user in the selected fuel dispensing unit 106 matches with the vehicle associated with the user, for fueling of the vehicle. The server 108 may also check if the secure fueling token entered at the selected fuel dispensing unit 106 is valid. The server 108 may confirm that the secure fueling token matches the vehicle associated with the user. If the secure fueling token and the vehicle match, the fueling operation for that vehicle is allowed to proceed.

In some embodiments, the server 108 may be configured to initiate a touchless and cardless fueling transaction by generating the secure fueling token and communicating the secure fueling token to the merchant point of sale system 112 associated with the selected fuel dispensing unit 106. The secure fueling token may correspond to an authorization credential that enables the fueling process without requiring the user to physically insert a card or manually interact with the fuel dispensing unit 106. In one example, the secure fueling token may be generated based on a combination of user account information, the selected fuel dispensing unit 106, and any program-specific or fleet-based discount data linked to the user account. It may be noted that transmission of the secure token to the merchant point of sale system 112 may preauthorize the fueling session and may allow the fuel dispensing unit 106 to be activated in a completely touchless manner.

In some embodiments, the at least one processor 200 is configured to transmit the secure fueling token directly to at least one of a point-of-sale (POS) system associated with the selected fuel dispensing unit, or the forecourt control interface 104 associated with the selected fuel dispensing unit, for enabling fueling of the vehicle automatically. Further, the at least one processor 200 is configured to inject the secure fueling token into at least one of the POS system or the forecourt control interface 104, associated with the selected fuel dispensing unit, in response to determining that the selected fuel dispensing unit does not have a direct integration with the fuel utilization management system. Further, the at least one processor 200 is configured to activate the selected fuel dispensing unit via at least one of the POS interface or the forecourt control interface, without generating the secure fueling token, to enable tokenless fueling of the vehicle.

In some embodiments, the at least one processor 200 may be configured to transmit the secure fueling token directly to the point-of-sale (POS) system or the forecourt control interface 104 associated with the selected fuel dispensing unit, such that the fueling of the vehicle is enabled automatically without requiring manual input of the token by the user. In cases where the selected fuel dispensing unit does not have a direct integration with the fuel utilization management system, the at least one processor 200 may inject the secure fueling token into the POS system or forecourt control interface, simulating the input as if it were entered by the user, thereby enabling seamless fueling at the vehicle. In some embodiments, the at least one processor 200 may also activate the selected fuel dispensing unit via the POS interface or forecourt control interface 104 without generating or transmitting a secure fueling token, enabling tokenless fueling of the vehicle. Furthermore, the at least one processor 200 may transmit, via a secure communication link, a secure fueling token entered by the user at the pump or interface to the forecourt control interface to validate the secure fueling token, ensuring that the transaction is properly authorized and securely recorded. These operations may be performed automatically in real time, providing a seamless fueling experience while maintaining security and compliance with any fleet or program rules.

In some embodiments, the at least one processor 200 may be configured to perform a token injection process, referred to herein as “token stuffing,” to enable fueling at a fuel dispensing unit even when the selected fuel dispensing unit or point-of-sale (POS) system does not have a direct integration with the fuel utilization management system. In token stuffing, the at least one processor 200 may simulate input from the driver by generating a secure fueling token and injecting the token into the POS or forecourt control interface, such that the POS system or fuel controller interprets the token as if it were manually entered by the driver at the pump. The at least one processor 200 may leverage its connection to the fuel controller or other authorized network to slip the token into the system, while preventing the driver from having to perform any manual entry or additional steps. As a result, the driver experiences seamless fueling without needing to interact with the POS, while the system ensures accurate authorization, secure transaction processing, and compliance with any fleet or fuel program policies. In some embodiments, the token stuffing process may also include logging and tracking of the injected token to ensure accurate auditing and reporting of fueling transactions.

In some embodiments, the server 108 may be configured to receive, from the user, a selection of a fuel product from among a plurality of fuel products. The fuel products may include one or more fuel grades available at the selected fuel dispensing unit 106. The one or more fuel grades may include at least one of regular unleaded, premium unleaded, diesel, biofuel, petrol, hydrogen, compressed natural gas (CNG), liquefied natural gas (LNG), ethanol-blended fuel, biodiesel, or electric charging. The user may be presented with a list of the plurality of fuel products on the computing device 110. The selection may be based on vehicle requirements, user preferences, corporate policy, or pricing. The server 108 may validate the availability of the selected fuel product at the selected fuel dispensing unit 106 before proceeding to authorize the fueling operation.

In some embodiments, the server 108 may be configured to transmit, using a secure communication link, the secure fueling token to the forecourt control interface 104 entered by the user to validate the secure fueling token. The secure communication link may utilize encrypted protocols such as Transport Layer Security to prevent interception or tampering of the secure fueling token during transmission. The forecourt control interface 104 may then decode or verify the secure fueling token, validate integrity and authorization, and may activate the fuel dispensing unit 106 accordingly.

In some embodiments, the server 108 may further be configured to monitor a fueling activity associated with the selected fuel dispensing unit 106 in real-time. Monitoring of the fueling activity may comprise at least one of verifying one or more of pump activation time, fuel quantity dispensed, transaction duration, and pricing details. It may be noted that real-time data may be collected from sensors or meters installed within the fuel dispensing unit 106 and may be transmitted to the server 108 via the forecourt control interface 104.

In some embodiments, the server 108 may be configured to determine, during the fueling of the vehicle, whether an amount of fuel dispensed by the selected fuel dispensing unit 106 is equal to an amount of the fuel received by the vehicle, based at least on a plurality of parameters associated with the selected fuel dispensing unit 106 and a plurality of parameters associated with the vehicle. The plurality of parameters associated with the selected fuel dispensing unit may comprise at least type of fuel dispensed, the amount of fuel dispensed, price of the fuel, and rate of the fuel. Further, the plurality of parameters associated with the vehicle may comprise at least fuel type of vehicle, real time fuel level within a fuel tank of the vehicle, and capacity of the fuel tank of the vehicle.

In some embodiments, the server 108 may be configured to determine one or more discrepancies during the fueling of the vehicle upon determining the amount of fuel dispensed by the selected fuel dispensing unit is not equal to the amount of the fuel received by the vehicle. In some embodiments, the server 108 may be configured to determine the one or more discrepancies in the fueling activity. The one or more discrepancies may include deviations from expected operational parameters such as unusually high fueling volumes, rapid pump reactivation after transaction closure, inconsistent pricing data, or irregular fueling duration.

The determination may be performed using predefined rule-based logic or machine learning models trained on historical fueling behavior. The server 108 may monitor real-time data from the fuel dispensing unit 106 and the forecourt control interface 104 to determine the one or more discrepancies. The determination of the one or more discrepancies may assist in identifying potential technical faults, user errors, or fraudulent behavior. In some embodiments, the server 108 may be configured to terminate the fueling of the vehicle upon determining the one or more discrepancies.

In some embodiments, the server 108 may be configured to determine difference between the amount of fuel dispensed by the selected fuel dispensing unit and the amount of the fuel received by the vehicle. Further, the server 108 may be configured to determine whether the difference is above a threshold value. In some embodiments, the threshold value corresponds to a predefined acceptable limit for the discrepancies. In one case, the server 108, upon determining that the difference is above the threshold value, may be configured to trigger at least one of a feedback alert. In another case, the server 108, upon determining that the difference is not above the threshold value (i.e., below or equal to the threshold value), may be configured to generate receipt data.

In some embodiments, the server 108 may be configured to dynamically repricing a unit price of fuel upon receiving the fueling request from the request source, based at least on a current retail price, a negotiated agreement between a fuel carrier and a merchant, a negotiated agreement between a fuel program and the merchant, a negotiated agreement between the carrier and the fuel program, or a schedule of fees. In some embodiments, the server 108 may be configured to generate in real time, receipt data from the selected fuel dispensing unit 106, based at least on the repricing of the unit price and upon determining the amount of fuel dispensed by the selected fuel dispensing unit is equal to the amount of the fuel received by the associated vehicle. The receipt data may include at least one of a quantity of fuel dispensed, total transaction cost, time of fueling, and the unique identification number associated with the selected fuel dispensing unit, and discount price of the fuel provided to the request source. The receipt data may be used for billing, reporting, and audit trails. In some embodiments, the server 108 may be configured to transmit the receipt data to the computing device 110 to initiate digital payment, upon fueling of the vehicle. The receipt data may be formatted for display within the computing device 110.

In some embodiments, the server 108 may be configured to trigger at least one of a feedback alert to the user upon determining the one or more discrepancies. The at least one feedback alert may be delivered through a push notification, a SMS, an email, or in-app notification on the computing device 110. The feedback alert may include descriptive information regarding the detected anomaly. In one example, the feedback alert may comprise “Unusually high fueling volume detected” or “Transaction time exceeds expected limit.” The at least one feedback alert may allow the user to verify the transaction accuracy or take corrective action.

In some embodiments, the server 108 may be configured to execute a fraud prevention protocol in response to determining the one or more discrepancies between the geographic location of the computing device 110, fueling time, and the selected fuel dispensing unit 106. In one example, if the geographic location of the computing device 110 is determined, via GPS or network-based geolocation, to be at a different location than the selected fuel dispensing unit 106 at the time of fueling, the server 108 may infer potential fraudulent activity or device spoofing. The fraud prevention protocol may include automatically disabling the fueling authorization, notifying the user, and logging the event for further audit. In one example, the server 108 may initiate multi-factor authentication or may require manual confirmation before continuing with the fueling operation.

In some embodiments, the server 108 may be configured to terminate the fueling session upon receiving a completion signal associated with the fueling process. The completion signal may be generated when the user manually ends the fueling session (e.g., by returning the nozzle), when a preset fuel limit is reached, or when the fuel dispensing unit 106 automatically detects fueling completion. Upon receipt of the completion signal, the server 108 may invalidate the secure fueling token, update session logs, and signal the forecourt control interface 104 to disable the fuel dispensing unit 106.

In some embodiments, the computing device 110 may comprise a graphical user interface (GUI) configured to display available fueling stations, the fuel dispensing unit 106, and associated receipt data. The GUI may enable the user such as a vehicle driver to securely interact with the system 100 and initiate the fueling operations. The computing device 110 may be implemented as a mobile device, such as a smartphone or tablet, equipped with a dedicated mobile application or a web-based interface accessible via a browser. Through the GUI, the user may perform actions such as logging in, viewing nearby fuel dispensing unit 106, selecting the fuel products, authorizing fueling sessions, and receiving the receipt data. The computing device 110 may include computing devices such as smartphones, tablets, laptop computers, or desktop terminals capable of real-time communication with the server 108 over the network 102. In some embodiment, the computing device 110 may include N number of computing devices corresponding to different users. In one embodiment, the computing device 110 may be integrated within the vehicle as a display unit. In another embodiment, the computing device 110 may correspond to a handheld device of a user. In another embodiment, the computing device 110 may be remotely placed i.e., outside the vehicle, without departing from the scope of the disclosure.

In some embodiments, the merchant point of sale 112 may be communicatively coupled to the forecourt control interface 104 and the fuel dispensing unit 106. In some embodiments, the merchant point of sale 112 may correspond to a system located at the fueling station that may manage payment processing and transaction coordination for fueling. The merchant point of sale 112 may act as a central controller that may communicate with the forecourt control interface 104 and the fuel dispensing unit 106. When the user may initiate the fueling session, the merchant point of sale 112 may receive the secure fueling token and fuel product details, sends them to a payment acquirer for approval, and then relay the authorization, spending limits, and any prompts (like loyalty or receipt options) to the fuel pump controller. After fueling is complete, the merchant point of sale 112 may capture the transaction details and may finalize the payment.

It will be apparent to one skilled in the art that above-mentioned components of the system 100 have been provided only for illustration purposes, without departing from the scope of the disclosure.

FIG. 2 illustrates a block diagram of the server 108 in accordance with an example embodiment of the present disclosure.

The server 108 may comprise at least one processor 200, a memory 202, an input/output circuitry 204, and a communication circuitry 206. In some embodiments, the at least one processor 200 may be configured for executing the one or more computer readable instructions stored in the memory 202. In some embodiments, the at least one processor 200 may be configured to receive automatically a fueling request in a real time. The fueling request may correspond to a request from a request source for fueling the vehicle. In some embodiments, the request source may comprise at least one of the vehicle associated with a company or the user responsible for paying for the fueling, a computing device associated with the user or the company, or a computing device of the vehicle.

The user may correspond to an autonomous driver or a physical driver of the vehicle. The fueling request may correspond to an action initiated by the user through a mobile application or an authorized interface installed on the computing device 110. The mobile application may correspond to a fuel utilization management application 114. The fueling request may include user identification credentials. Upon receiving the fueling request, the at least one processor 200 may initiate a sequence of backend processing operations that may verify the user identification credentials, and may assess eligibility for fueling.

In some embodiment, the at least one processor 110 may be configured to validate that the fueling request is not fraudulent, based on historical information of the request source, prior to determine geographic location of the vehicle and generate a secure fueling token. The historical information includes at least purchase history and location history. Further, the at least one processor 110 may be configured to preauthorize a purchasing power of the secure fueling token, based on the historical information, business rules specified by the user associated with the vehicle, and business rules specified by the fuel program.

In some embodiments, the at least one processor 200 may be configured to determine a geographic location of the vehicle upon receiving the fueling request from the request source. The geographic location of the vehicle may be determined through one or more localization methods. The one or more localization methods may include at least one of GPS coordinates, Wi-Fi-based location services, or cellular triangulation. The geographic location may be used in real time to match the user to nearby fueling stations.

In some embodiments, the at least one processor 200 may be configured to generate a list of one or more fuel dispensing units for fueling the vehicle, based at least on the determined current geographic location of the vehicle. Further, the at least one processor 200 may be configured to generate the list of the one or more fuel dispensing units within a predefined proximity for fueling the vehicle, based on one or more parameters associated with the user. The one or more parameters may include at least one of a transaction history, the user credentials, vehicle information, fueling preferences, or time-of-day usage patterns. In some embodiments, the list of one or more fuel dispensing units may further be refined based on integration with the merchant point of sale system 112 to ensure the fuel dispensing units 106 with active payment or loyalty program compatibility may be prioritized. In some embodiments, the at least one processor 200 may be configured to send the generated list of the one or more fuel dispensing units to the user.

In some embodiments, the generated list of the one or more fuel dispensing units may be displayed over the fuel utilization management application 114 installed on the computing device 110 operated by the user. In some embodiments, the at least one processor 200 may be configured to receive a selection of a fuel dispensing unit 106 from the generated list of the one or more fuel dispensing units, from the user. The user may interact with the fuel utilization management application 114 to select the fuel dispensing unit 106. The selection may include identifying information such as a pump number, a location identifier (ID), or QR code corresponding to the selected fuel dispensing unit 106. The selection may also include interaction with the merchant point of sale system 112 to preauthorize payment or apply user-specific discounts prior to fueling.

In some embodiments, the at least one processor 200 may be configured to identify the fuel dispensing unit 106 associated with the vehicle using a plurality of identification modalities. The plurality of identification modalities may be performed manually or automatically. In one example, the user may interact with the fuel utilization management application 114 installed on the computing device 110 to select a specific fuel dispensing unit 106 from the list of the one or more fuel dispensing units. The selection may include identifying information such as a fuel dispensing unit number, the location ID, or the QR code corresponding to the selected fuel dispensing unit 106.

In some embodiments, the at least one processor 200 may be configured to receive, via an image capturing unit installed within the vehicle, one or more images of the selected fuel dispensing unit 106 captured by the image capturing unit. The image capturing unit may correspond to a camera. The image capturing unit may visually identify which fuel dispensing unit the vehicle is parked near.

In some embodiments, the at least one processor 200 may be configured to analyze, using the artificial intelligence (AI) vision module 208, the one or more images of the selected fuel dispensing unit 106 to determine a unique identification number associated with the fuel dispensing unit 106. The unique identification number may correspond to the unique label or the unique code displayed on the fuel dispensing unit 106. In some embodiments, the AI vision module 208 may be configured to analyze the one or more images captured by the image capturing unit installed on the vehicle. The AI vision module 208 may process the one or more images to identify and extract a unique identification number or other distinguishing features of the fuel dispensing unit 106. In an alternate embodiment, the at least one processor 200 may be configured to analyze AI based verification of the vehicle (for example, a truck) to determine a driver identity, using the AI vision module 208. In some embodiments, fuel level or usage inference may be extracted from video or electronic logging device (ELD) data.

In some embodiments, the at least one processor 200 may be further configured to compare the determined unique identification number with the selected fuel dispensing unit 106 to confirm the selected fuel dispensing unit 106 by the user. The comparison may help confirm whether the user has correctly selected the same fuel dispensing unit 106 that the vehicle is actually located next to. In an alternate embodiment, the at least one processor 200 may be configured to compare the determined driver identity with the ELD data to confirm whether the fuel dispensing unit 106 is selected by the correct user.

Further, the at least one processor 200 may further be configured to determine a fueling position of the vehicle using the captured one or more images. In some embodiments, the at least one processor 200 may determine if the user has parked the vehicle in the fueling position which is correct for refueling the vehicle from the selected fuel dispensing unit 106. Further, the at least one processor 200 may also be configured to determine if the user has parked the vehicle in the fueling position for more a threshold time period. The vehicle parked for more than the threshold time period indicates that the vehicle is ready to be fueled.

In some embodiments, the at least one processor 200 may be configured to automatically determine the fuel dispensing unit 106 without user input using a combination of the geographic location data, such as GPS coordinates, Wi-Fi triangulation, or cellular network triangulation, to determine which fuel dispensing unit 106 the vehicle is adjacent to. In some embodiments, the at least one processor 200 may also implement proximity-based detection or vision-based detection methods to enhance or replace manual selection. In one example, the image capturing unit may be configured to capture the one or more images of fueling area. The at least one processor 200 may analyze the one or more images using the AI vision module 208 to detect a unique pump number, a visual label, or a code displayed on the fuel dispensing unit 106. In another example, the at least one processor 200 may utilize the proximity-based detection methods, such as Bluetooth or RFID to identify the closest fuel dispensing unit 106 to the vehicle. In some embodiments, two or more identification modalities may be combined to verify the selection of the fuel dispensing unit 106 before initiating fueling transaction.

In some embodiments, the at least one processor 200 may be configured to generate automatically a secure fueling token associated with the selected fuel dispensing unit 106, for the user. The secure fueling token may be digitally linked to the fuel dispensing unit 106 that the user has selected. The secure fueling token may act like a temporary, unique permission slip that may allow the selected fuel dispensing unit 106 to be activated for fueling. The secure fueling token may be a time-bound, cryptographically generated identifier that may uniquely link a user session to the selected fuel dispensing unit 106. The secure fueling token may include encoded metadata such as user ID, dispenser ID, fuel product selection, authorization parameters, and token expiration time. The secure fueling token may serve as a digital key to enable fuel delivery and prevent unauthorized access or spoofing attempts.

In some embodiments, the at least one processor 200 may be further configured to validate the secure fueling token entered by the user in the selected fuel dispensing unit 106 matches with the vehicle associated with the user, for fueling of the vehicle. The at least one processor 200 may also check if the secure fueling token entered at the selected fuel dispensing unit 106 is valid. The at least one processor 200 may confirm that the secure fueling token matches the vehicle associated with the user. If the secure fueling token and the vehicle match, the fueling operation for that vehicle is allowed to proceed.

In some embodiments, the at least one processor 200 may be configured to initiate a touchless and cardless fueling transaction by generating the secure fueling token and communicating the secure fueling token to the merchant point of sale system 112 associated with the selected fuel dispensing unit 106. The secure fueling token may correspond to an authorization credential that enables the fueling process without requiring the user to physically insert a card or manually interact with the fuel dispensing unit 106. In one example, the secure fueling token may be generated based on a combination of user account information, the selected fuel dispensing unit 106, and any program-specific or fleet-based discount data linked to the user account. It may be noted that the transmission of the secure token to the merchant point of sale system 112 may preauthorize the fueling session and may allow the fuel dispensing unit 106 to be activated in a completely touchless manner.

In some embodiments, the at least one processor 200 may be configured to receive, from the user, the selection of a fuel product from among the plurality of fuel products. The fuel products may include the one or more fuel grades available at the selected fuel dispensing unit 106. The one or more fuel grades may include at least one of regular unleaded, premium unleaded, diesel, biofuel, petrol, hydrogen, compressed natural gas (CNG), liquefied natural gas (LNG), ethanol-blended fuel, biodiesel, or electric charging. The user may be presented with the list of the plurality of fuel products on the computing device 110. The selection may be based on vehicle requirements, user preferences, corporate policy, or pricing. The at least one processor 200 may validate the availability of the selected fuel product at the selected fuel dispensing unit 106 before proceeding to authorize the fueling operation. The selection may also include interaction with the merchant point of sale system 112 to preauthorize payment or apply user-specific discounts prior to fueling.

In some embodiments, the at least one processor 200 may be configured to transmit, using the secure communication link, the secure fueling token to the forecourt control interface 104 entered by the user to validate the secure fueling token. The secure communication link may utilize encrypted protocols such as Transport Layer Security to prevent interception or tampering of the secure fueling token during transmission. The forecourt control interface 104 may then decode or verify the secure fueling token, validate integrity and authorization, and may activate the fuel dispensing unit 106.

In some embodiments, the at least one processor 200 may be further configured to monitor the fueling activity associated with the selected fuel dispensing unit 106 in real-time. Monitoring of the fueling activity may comprise at least one of verifying one or more of pump activation time, fuel quantity dispensed, transaction duration, and pricing details. It may be noted that real-time data may be collected from sensors or meters installed within the fuel dispensing unit 106 and may be transmitted to the at least one processor 200 via the forecourt control interface 104.

In some embodiments, the at least one processor 200 may be configured to determine, during the fueling of the vehicle, whether an amount of fuel dispensed by the selected fuel dispensing unit 106 is equal to an amount of the fuel received by the vehicle, based at least on a plurality of parameters associated with the selected fuel dispensing unit 104 and a plurality of parameters associated with the vehicle. The plurality of parameters associated with the selected fuel dispensing unit may comprise at least type of fuel dispensed, the amount of fuel dispensed, price of the fuel, and rate of the fuel. Further, the plurality of parameters associated with the vehicle may comprise at least fuel type of vehicle, real time fuel level within a fuel tank of the vehicle, and capacity of the fuel tank of the vehicle.

In some embodiments, the at least one processor 200 may be configured to determine one or more discrepancies during the fueling of the vehicle upon determining the amount of fuel dispensed by the selected fuel dispensing unit is not equal to the amount of the fuel received by the vehicle. In some embodiments, the at least one processor 200 may be configured to determine the one or more discrepancies in the fueling activity. The one or more discrepancies may include deviations from expected operational parameters such as unusually high fueling volumes, rapid pump reactivation after transaction closure, inconsistent pricing data, or irregular fueling duration. The determination may be performed using predefined rule-based logic or machine learning models trained on historical fueling behavior. The at least one processor 200 may monitor real-time data from the fuel dispensing unit 106 and the forecourt control interface 104 to determine the one or more discrepancies. The determination of the one or more discrepancies may assist in identifying potential technical faults, user errors, or fraudulent behavior. In some embodiments, the at least one processor 200 may be configured to terminate the fueling of the vehicle upon determining the one or more discrepancies.

In some embodiments, the at least one processor 200 may detect one or more discrepancies based on a combination of parameters, including, but not limited to, data received from electronic logging devices (ELDs) associated with the vehicle, fuel level or flow sensors of the vehicle or fuel dispensing unit, visual data obtained from cameras or other vision systems, and override preferences or rules set by a fleet manager. Upon detecting the one or more discrepancies, the at least one processor 200 may pause or terminate the fueling process automatically, thereby enforcing compliance with the expected fueling parameters. In some embodiments, the real-time monitoring and enforcement logic may prioritize or weight the different inputs according to predefined rules, such that certain sensor readings or fleet preferences may override others, ensuring safe, accurate, and controlled fueling operations.

In some embodiments, the at least one processor 200 may be configured to determine difference between the amount of fuel dispensed by the selected fuel dispensing unit and the amount of the fuel received by the vehicle. Further, the at least one processor 200 may be configured to determine whether the difference is above the threshold value. In one case, the at least one processor 200 upon determining that the difference is above the threshold value, may be configured to trigger at least one of a feedback alert. In another case, the at least one processor 200 upon determining that the difference is not above the threshold value (i.e., below or equal to the threshold value), may be configured to generate receipt data.

In some embodiments, the at least one processor 200 may be further configured to generate receipt data for the fueling transaction in real time, the receipt data reflecting one or more discounts, adjustments, or dynamic repricing applied to the unit price of fuel, even if such discounts or adjustments are not reflected at the selected fuel dispensing unit during fueling. The at least one processor 200 may calculate a final transaction total based on the dynamic pricing, negotiated agreements, or promotional programs associated with the request source. The at least one processor 200 may then transmit the receipt data directly to a computing device 110 associated with the user or vehicle in real time, such that the user receives an accurate record of the transaction, including any discounted totals, immediately upon completion of fueling. In some embodiments, the receipt data may include information such as the quantity of fuel dispensed, total transaction cost, discounted price, time of fueling, and identifier of the selected fuel dispensing unit.

In some embodiments, the at least one processor 200 may be configured to dynamically repricing a unit price of fuel upon receiving the fueling request from the request source, based at least on a current retail price, a negotiated agreement between a fuel carrier and a merchant, a negotiated agreement between a fuel program and the merchant, a negotiated agreement between the carrier and the fuel program, or a schedule of fees.

In one example, the at least one processor 200 may calculate a discounted fuel price in real time based on the combination of any applicable agreements or rebates, such that the final unit price displayed to the user reflects any discounts or surcharges applicable under the negotiated terms. The dynamic repricing may occur automatically, without manual intervention, and may be updated for each fueling request to ensure that the unit price corresponds to the most current agreements and pricing conditions. In some embodiments, the dynamic repricing may also account for geographic location, fuel availability, or other parameters associated with the selected fuel dispensing unit.

In some embodiments, the at least one processor 200 may be configured to generate in real time, receipt data from the selected fuel dispensing unit 106, based at least on the repricing of the unit price and upon determining the amount of fuel dispensed by the selected fuel dispensing unit is equal to the amount of the fuel received by the associated vehicle. The receipt data may include at least one of a quantity of fuel dispensed, total transaction cost, time of fueling, and the unique identification number associated with the selected fuel dispensing unit, and discount price of the fuel provided to the request source. The receipt data may be used for billing, reporting, and audit trails. In some embodiments, the at least one processor 200 may be configured to transmit the receipt data to the computing device 110 to initiate digital payment, upon fueling of the vehicle. The receipt data may be formatted for display within the computing device 110.

In some embodiments, the at least one processor 200 may be configured to trigger the at least one of the feedback alert to the user upon determining the one or more discrepancies. The at least one feedback alert may be delivered through the push notification, the SMS, the email, or the in-app notification on the computing device 110. The feedback alert may include descriptive information regarding the detected anomaly. In one example, the feedback alert may comprise “Unusually high fueling volume detected” or “Transaction time exceeds expected limit.” The at least one feedback alert may allow the user to verify the transaction accuracy or take corrective action.

In some embodiments, the at least one processor 200 may be configured to execute the fraud prevention protocol in response to determining the one or more between the geographic location of the computing device 110, fueling time, and the selected fuel dispensing unit 106. In one example, if the computing device 110 is determined, via GPS or network-based geolocation, to be at a different location than the selected fuel dispensing unit 106 at the time of fueling, the at least one processor 200 may infer potential fraudulent activity or device spoofing. The fraud prevention protocol may include automatically disabling the fueling authorization, notifying the user, and logging the event for further audit. In one example, the at least one processor 200 may initiate multi-factor authentication or may require manual confirmation before continuing with the fueling operation.

In some embodiments, the at least one processor 200 may be configured to terminate the fueling session upon receiving a completion signal associated with the fueling process. The completion signal may be generated when the user manually ends the fueling session (e.g., by returning the nozzle), when a preset fuel limit is reached, or when the fuel dispensing unit 106 automatically detects fueling completion. Upon receipt of the completion signal, the server 108 may invalidate the secure fueling token, update session logs, and signal the forecourt control interface 104 to disable the fuel dispensing unit 106.

The at least one processor 200 may include suitable logic, circuitry, and/or interfaces that are operable to execute the one or more computer readable instructions stored in the memory 202 to perform predetermined operations. The at least one processor 200 may be configured to manage and execute secure fueling transactions, process fueling requests from the computing device 110, and interact with the fuel dispensing unit 106 and the forecourt control interface 104. In some embodiments, the at least one processor 200 may be configured to store the fueling preferences, the user credentials, the vehicle data, the transaction history, and the fueling token information in the memory 202 communicatively coupled to the at least one processor 200. In one embodiment, the at least one processor 200 may be configured to decode and execute any instructions received from one or more other electronic devices or server(s). The at least one processor 200 may be configured to execute one or more computer-readable program instructions, such as program instructions to carry out any of the functions described in this description. Further, the processor may be implemented using the at least one processor 200 technologies known in the art. Examples of the at least one processor 200 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to store the user credentials and the authorization tokens. The memory 202 may be configured to include the instructions to authenticate the user. The memory 202 may be configured to store the receipt data. The receipt data includes at least one of a quantity of fuel dispensed, total transaction cost, time of fueling, and the unique identification number associated with the selected fuel dispensing unit, and discount price of the fuel provided to the request source. In some embodiments, the memory 202 may be configured to store the plurality of parameters associated with the selected fuel dispensing unit 106. The plurality of parameters associated with the selected fuel dispensing unit may comprise at least one type of fuel dispensed, the amount of fuel dispensed, price of the fuel, and rate of the fuel. In some embodiment, the memory 202 may be configured to store the plurality of parameters associated with the vehicle. The plurality of parameters associated with the vehicle comprises at least one of a fuel type of vehicle, real time fuel level within a fuel tank of the vehicle, and capacity of the fuel tank of the vehicle.

It is apparent to a person with ordinary skill in the art that the one or more computer readable instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 108 may further comprise an input/output circuitry 204. In some embodiments, the input/output circuitry 204 may act as a medium to transmit input from the interface to and from the system 100. In some embodiments, the input/output circuitry 204 may refer to the hardware and software components that facilitate bidirectional data exchange, including user authentication credentials, fueling authorization requests, fuel product selections, vehicle ID inputs, and anomaly alerts. In one example, the server 108 may include the GUI (not shown) as part of the input circuitry, which may allow the user to enter the user credentials, select fuel dispensing units, authorize fueling sessions, or view real-time fueling statuses. The input/output circuitry 204 may include various input components such as keyboards, touchscreens, and graphical widgets, enabling the user to provide data such as vehicle registration numbers, fueling preferences, merchant selections, or cost center codes. In another example, the input/output circuitry 204 may include various output circuitry such as a display to convey information including fueling transaction confirmations, pricing details, fraud alerts, station availability, or enterprise-specific fueling policies.

In some embodiments, the server 208 may further comprise a communication circuitry 206. The communication circuitry 206 may allow the server 108 to exchange data or information with external systems, the forecourt control interface 104, the computing device 110, and the fuel dispensing unit 106. Further, the communication circuitry 206 may include network interfaces, protocols, and software modules responsible for sending and receiving data or information. In some embodiments, the communication circuitry 206 may include Ethernet ports, Wi-Fi adapters, or communication protocols like HTTP or MQTT for connecting with other systems. The communication circuitry 206 may further include components such as communication modules (e.g., Wi-Fi, Ethernet, cellular), transceivers, antennas, and protocols (e.g., TCP/IP, MQTT, SNMP) for exchanging data with other systems or network devices. In some embodiments, the communication circuitry 206 may also enable the server 108 to transmit pump control signals, receive fueling status updates, and monitor transaction events.

The communication circuitry 206 may further ensure secure and reliable communication between the server 108 and the computing device 110.

It will be apparent to one skilled in the art the above-mentioned components of the server 108 have been provided only for illustration purposes, without departing from the scope of the disclosure.

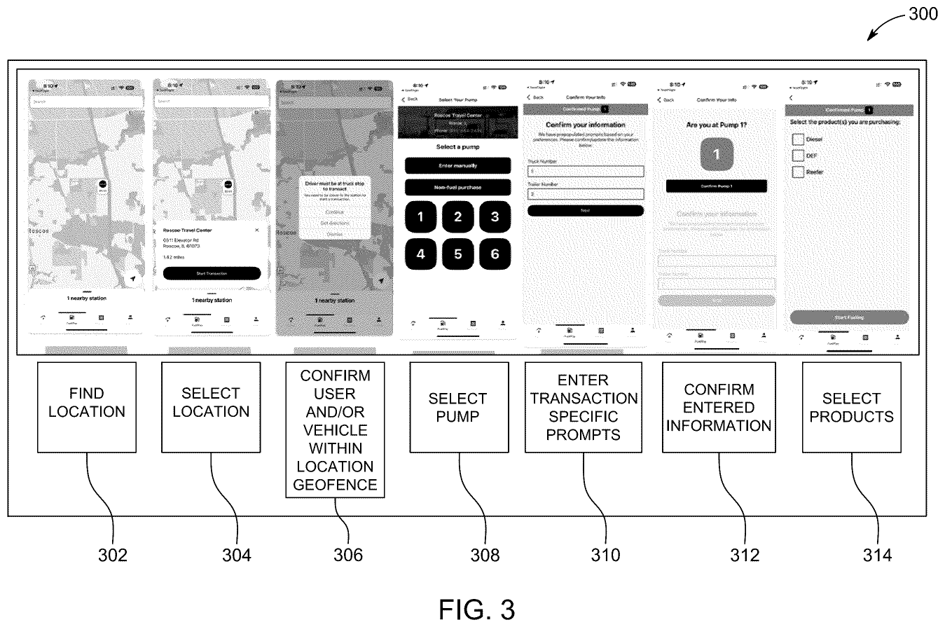

FIG. 3 illustrates an example user interface flow diagram 300 of a method for controlling a vehicle fueling transaction in accordance with an example embodiment of the present disclosure.

In some embodiments, the vehicle fueling transaction may be executed by the user using the fuel utilization management application 114 installed within the computing device 110 operated by the user.

At operation 302, the fuel utilization management application 114 allows the user to view a “Find Location” screen, which may include a selectable list or a map of the one or more nearby stations. In one example, the fuel utilization management application 114 may display “1 nearby station”, indicating that a single qualifying station has been detected within the proximity of the vehicle.

At operation 304, the user may select the fuel dispensing unit 106 from the displayed list of the one or more fuel dispensing units available, using the fuel utilization management application 114. The selection of the fuel dispensing unit 106 may trigger the computing device 110 to communicate with the at least one processor 200 to initiate validation and contextual data loading for the selected fuel dispensing unit 106. In one example, the selection may be based on criteria such as station name, address, fuel pricing, or enterprise-specific contracts associated with the driver's account. Upon selection, the at least one processor 200 may retrieve and transmit station-specific data, including number of the fuel dispensing unit 106, fuel product types, and current operational status of the fuel dispensing units 106 associated with the fueling station.

At operation 306, the at least one processor 200 may perform a location validation to ensure that the computing device 110 is physically located within a predefined geofence zone associated with the selected fueling station. In some embodiments, the at least one processor 200 may perform the location validation to ensure that the vehicle of the user is physically located within a predefined geofence zone associated with the selected fueling station. The location of the vehicle may be fetched by the at least one processor 200 using an onboard navigation system of the vehicle. The at least one processor 200 may help to prevent fraudulent or remote fueling attempts. The at least one processor 200 may compare the geographic location of the computing device 110 with the predefined geofence zone for the selected fueling station. In case, the geographic location is determined to be within the predefined geofence zone, then the fueling process may proceed to the operation 308.

At operation 308, the user may be presented with a “Select Pump” option on the fuel utilization management application 114 to select the fuel dispensing unit 106 by selecting a pump number. The “Select Pump” option may allow the user to input the pump number. In one example, the user may be presented with a filtered list of currently active or available pump numbers to reduce errors.

At operation 310, the user may receive transaction specific prompts the fuel utilization management application 114 to enter vehicle-specific information such as a truck number, trailer number, or fleet ID. The vehicle-specific information may be used for enterprise tracking, driver authorization, transaction logging, or eligibility verification. It may be noted that the entered vehicle information may be cross-validated with enterprise backend systems or historical driver profiles to enforce internal policy compliance or streamline documentation.

At operation 312, a “Confirm Pump” option may be displayed on the fuel utilization management application 114, for the user to verify and confirm the previously entered pump number. The confirmation may reduce the risk of accidental fuel delivery to an incorrect fuel dispensing unit. In one embodiment, a summary of the selected pump number, station name, and associated fuel dispensing unit 106 metadata may be presented to the user for accepting or changing the selection.

At operation 314, the user may be presented with a list of available fuel products that are dispensed from the confirmed fuel dispensing unit 106. The fuel product list may include at least one of the diesel, diesel exhaust fluid (DEF), reefer fuel, and other supported fuel types available at the selected pump station. The user may be required to select one or more fuel products to proceed. The selection may be transmitted to the at least one processor 200 to generate a corresponding authorization token or control signal that may enable the fuel dispensing unit 106 to allow dispensing of the selected fuel product for the verified vehicle.

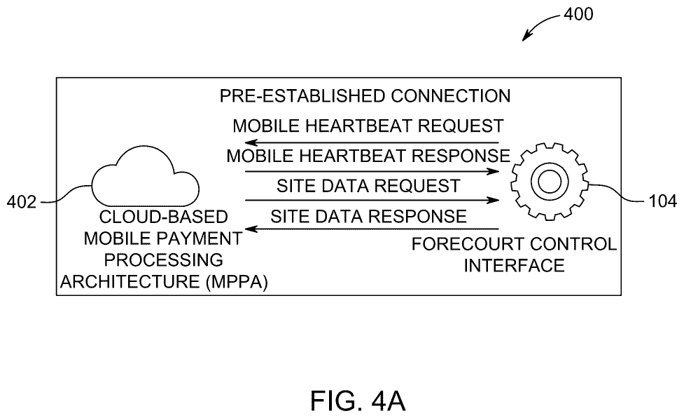

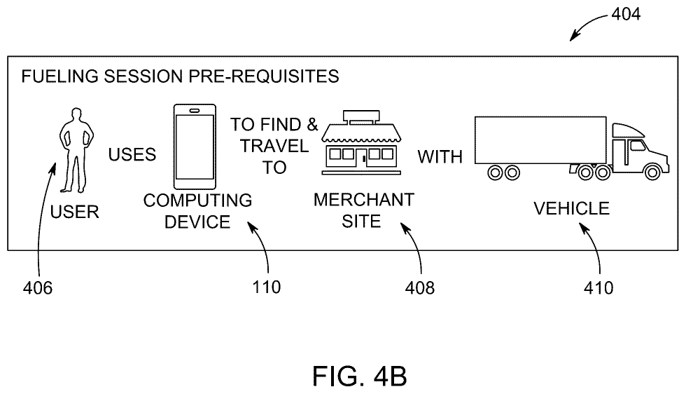

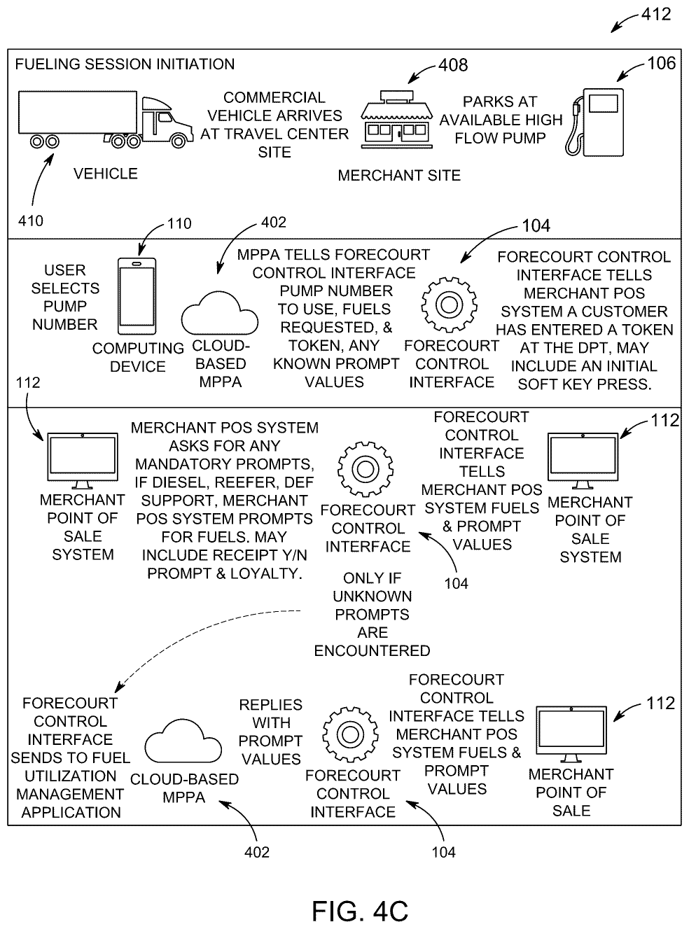

FIG. 4A illustrates a communication sequence 400 between the system 100 and the forecourt control interface 104 in accordance with an example embodiment of the present disclosure.

In some embodiments, a pre-established connection may be maintained between a cloud-based mobile payment processing architecture (MPPA) 402 and the forecourt control interface 104 to facilitate real-time, secure data exchange. The system 100 may comprise the cloud-based MPPA 402 that enables mobile-based fueling workflows by interfacing with the forecourt control interface 104 deployed at the fueling station. The communication sequence 400 may include a mobile heartbeat request sent from the forecourt control interface 104 to the cloud-based MPPA 402 followed by a mobile heartbeat response returned by the cloud-based MPPA 402. A handshake may ensure active connectivity and synchronization between the cloud-based MPPA 402 and the forecourt control interface 104.

In some embodiments, the system 100 may initiate a site data request to retrieve station-specific information such as pump availability, fuel types, pricing, and operational status. The forecourt control interface 104 may respond with a site data response, which may be then used by the system 100 to update the user interface and drive downstream operations such as pump selection and authorization. The secure, bidirectional exchange of the heartbeat and the site station-specific information may ensure that the computing device 110 may remain in continuous alignment with the forecourt control interface 104.

FIG. 4B illustrates a block diagram 404 showing fueling session pre-requisites in accordance with an example embodiment of the present disclosure.

In some embodiments, the fueling operation may begin with a user 406 who is authorized to operate the vehicle. The user 406 may utilize the system 100 to locate, navigate to, and initiate the fueling operation at supported merchant site 408. The at least one processor 200 may interface with various backend services provided by system 100 to determine site availability, enable geolocation-based suggestions, and facilitate session authentication.

In some embodiments, the user may travel to the merchant site 408 that may include the forecourt control interface 104 capable of communicating with the system 100 to enable remote pump control, data exchange, and secure transaction handling. The merchant site 408 can be interchangeably termed as the fueling station. The fueling session may be further predicated on the presence of the vehicle operated by the user. The vehicle may correspond to a commercial vehicle. The commercial vehicle may be identified by unique metadata such as fleet ID, license plate, or embedded telematics data, which may be used during site authorization.

FIG. 4C illustrates an example flow diagram 412 showing a fueling session initiation process in accordance with an example embodiment of the present disclosure.

In some embodiments, the fueling session initiation process may be implemented through the system 100. The vehicle 410 may arrive at the merchant site 408. The vehicle 410 may park at an available high-flow diesel or commercial fuel dispensing unit located in a diesel/commercial forecourt 414. The user 406 may initiate the fueling session by interacting with the computing device 110. Within the user interface of the computing device 110, the user 406 may select a pump number corresponding to the diesel/commercial forecourt 414 at which the vehicle 410 is parked.

In some embodiments, the cloud-based MPPA 402 may be configured to facilitate token-based fueling transactions. The cloud-based MPPA 402 may transmit the selected pump number, the requested fuel type, a transaction token, and any known prompt values (e.g., whether the driver wants a printed receipt or is participating in a loyalty program) to the forecourt control interface 104.

In some embodiments, the forecourt control interface 104 may be responsible for translating the token-based fueling request into a compatible format for communication with legacy POS systems and pump controllers. The forecourt control interface 104 may inform the POS system that a token entry has been detected at the dispenser terminal and may simulate an initial soft key press event to begin a session on the POS.

In some embodiments, the merchant point of sale system 112 may determine whether any additional prompts are required for session validation. The additional prompts may include mandatory prompts for diesel selection, reefer or DEF fueling options, receipt printing confirmation, or loyalty ID input. The merchant point of sale system 112 may issue the additional prompt requirements back to the forecourt control interface 104.

In some embodiments, if the required prompt values are already known, the forecourt control interface 104 may communicate the resolved fuel selection and prompt values back to the merchant point of sale system 112, and may allow the transaction to proceed. Further, in cases where unknown prompts are encountered the forecourt control interface 104 may send a query back to the cloud-based MPPA 402 requesting appropriate responses.

In some embodiments, upon receiving the prompt request from the forecourt control interface 104, the cloud-based MPPA 402 may reply with the needed prompt values, and may ensure compatibility with the merchant point of sale system 112. The prompt values may then be relayed by the forecourt control interface 104 back to the merchant point of sale system 112. Once all prompt values are resolved and fuel types are confirmed, the forecourt control interface 104 may transmit a final message to the merchant point of sale system 112 specifying the selected fuels and prompt values.

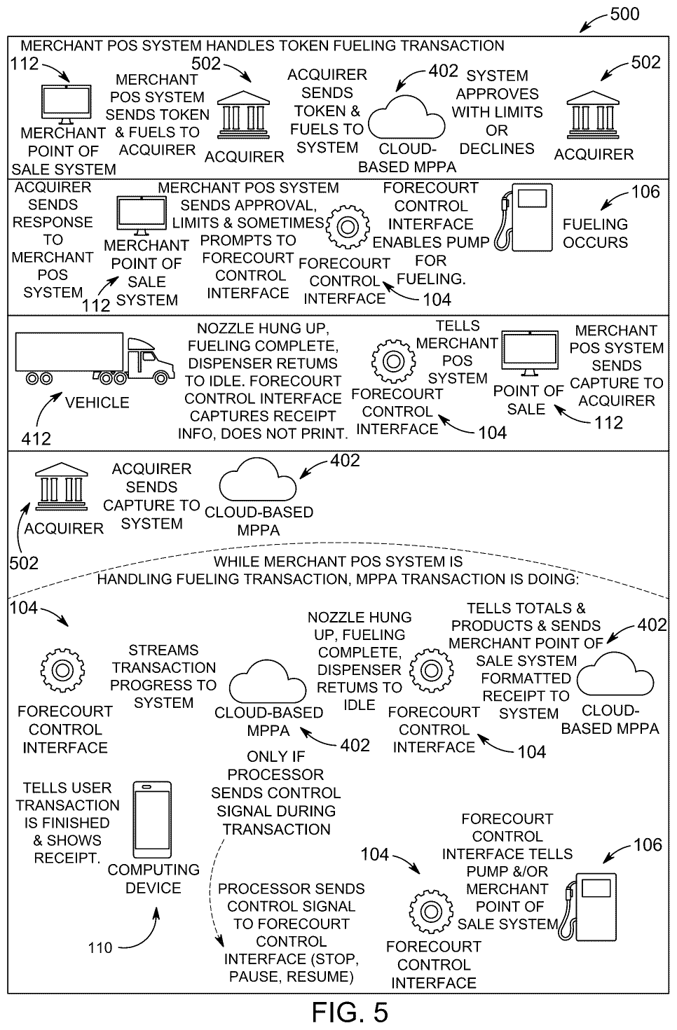

FIG. 5 illustrates a flow diagram 500 depicting a token-based fueling transaction process in accordance with an example embodiment of the present disclosure.

In some embodiments, the token-based fueling transaction process may begin when the merchant point of sale system 112 receives the secure fueling token and associated fuel configuration (e.g., diesel, reefer, diesel exhaust fluid (DEF)) from the computing device 110 via the forecourt control interface 104. The merchant point of sale system 112 may then initiate the fueling transaction by forwarding the secure fueling token and fuel details to an acquirer 502. The acquirer 502 may be an intermediary, that may relay the secure fueling token and fuel data to the cloud-based MPPA 402 for validation and authorization. In some embodiments, upon receiving the transaction request, the cloud-based MPPA 402 may evaluate the secure fueling token and requested fuel products. Based on the user's eligibility, account status, and business rules, the cloud-based MPPA 402 may either approve the transaction or decline the transaction. The cloud-based MPPA 402 may then return the result to the acquirer 502, which may forward back to the merchant point of sale system 112.

In some embodiments, following receipt of the approval or decline, the merchant point of sale system 112 may interpret the cloud-based MPPA 402 response and may forward the corresponding information to the forecourt control interface 104. The information may include product-specific fueling limits (e.g., maximum gallons or dollars) and one or more prompts required for compliance or operational logic. Upon receiving the information, the forecourt control interface 104 may enable the desired fuel dispensing unit 106 to begin fueling. In some embodiments, the user may begin fueling, and the fuel is dispensed. When the fueling process is complete, and the nozzle is returned to its cradle, the fuel dispensing unit 106 may transition back to an idle state. The forecourt control interface 104 may capture relevant fueling receipt information such as product type, volume dispensed, and total cost. Notably, the forecourt control interface 104 may not print the receipt locally but instead may forward the information to the merchant point of sale system 112.

In some embodiments, once the merchant point of sale system 112 may receive the transaction completion data from the forecourt control interface 104, the merchant point of sale system 112 may send a capture message to the acquirer 502 to finalize the transaction. The acquirer 502 may subsequently forward the capture to the cloud-based MPPA 402 to record and settle the session. In some embodiments, parallel to the POS-driven flow, the cloud-based MPPA 402 may maintain real-time awareness of the transaction state through a second stream.

During the entire fueling session, the forecourt control interface 104 may continuously stream transaction progress updates to the cloud-based MPPA 402. The transaction progress updates may include key lifecycle events such as nozzle lift, fuel dispensing, nozzle hang-up, and dispenser idle transition.

In some embodiments, upon detecting that fueling is complete and the fuel dispensing unit 106 has returned to the idle state, the forecourt control interface 104 may transmit detailed transaction totals, including volumes and fuel types to the cloud-based MPPA 402. Further, the forecourt control interface 104 may forward a copy of the receipt directly to the cloud-based MPPA 402 for user access or archival purposes. In some embodiments, throughout the fueling session, the cloud-based MPPA 402 may retain the capability to control the fuel dispensing unit 106 remotely via the forecourt control interface 104. The forecourt control interface 104 may issue operational commands such as stop, pause, or resume based on user actions or system conditions. Once the transaction is fully completed, the cloud-based MPPA 402 may communicate to the user through the mobile application, may display ma final confirmation, and may render the receipt in digital form.

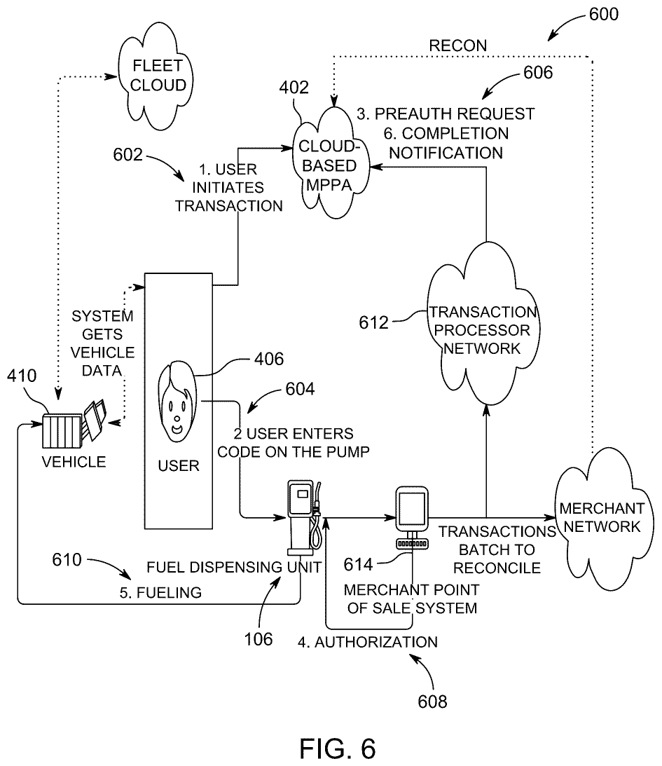

FIG. 6 illustrates a transaction flow diagram 600 in accordance with an example embodiment of the present disclosure.

In some embodiments, a fueling transaction process may begin when the user 406, operating the vehicle may initiate a fueling transaction using the application installed on the computing device 110. At step 602, the user 406 may launch the application and initiate the request to start the fueling operation at the fueling station that may include the fuel dispensing unit 106. The computing device 110 may communicate with at least one processor 200 to begin validation and fueling authorization.

At step 604, once the transaction has been initiated on the computing device 110, the user 406 may physically arrive at the forecourt control interface 104 and may manually enter a code on a user interface of the fuel dispensing unit 106. The code may comprise a pump number or a unique fueling identifier. The code may bind the fuel dispensing unit 106 to the fueling session initialized by the user.

At step 606, the at least one processor 200 may generate and transmit a preauthorization request to a transaction processor network 612. The preauthorization request may include data such as the driver identification, vehicle-specific metadata, selected pump number, requested fuel product, and enterprise policy constraints. The preauthorization request may be transmitted to the merchant point of sale system 112. The merchant point of sale system 112 may verify transaction parameters and may forward the request to the transaction processor network 612 for authorization.

At step 608, once the transaction processor network 612 may approve the preauthorization request, an authorization signal may be relayed back to the merchant point of sale system 112, which in turn may instruct the forecourt control interface 104 to enable the corresponding fuel dispensing unit 106. Upon receiving the authorization signal, the fuel dispensing unit 106 may transition to a ready state and may await fueling initiation by the user 406.

At step 610, the user 406 may begin dispensing fuel into the vehicle 410 using the fuel dispensing unit 106. During the process, real-time fueling data such as volume dispensed, fuel grade, pricing, and pump status may be continuously monitored by the forecourt control interface 104. The forecourt control interface 104 may transmit the live fueling data back to the system 100, which may record and associate the real-time fueling data with the active transaction session.

In some embodiments, when the fueling operation is complete, a fueling end event may be triggered at the fuel dispensing unit 106. The fueling end event may be communicated to the forecourt control interface 104 and may be subsequently relayed to the merchant point of sale system 112 and the at least one processor 200. The system 100 may generate a fueling completion record, which may include the final dispensed quantity, total cost, pump ID, and transaction metadata.

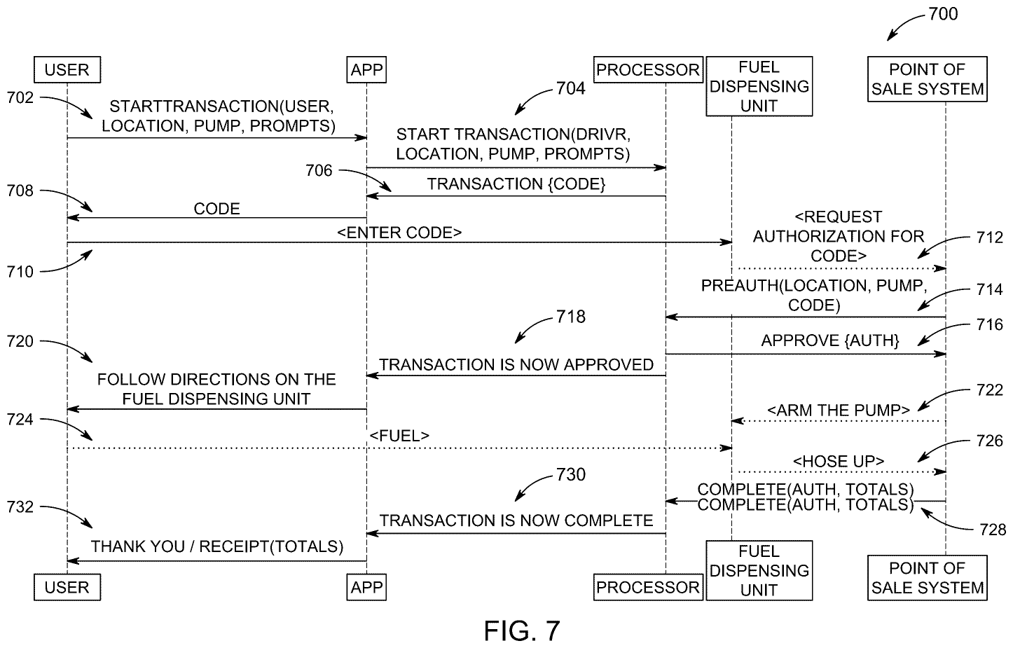

FIG. 7 illustrates a sequence diagram 700 representing a method for authorizing and executing a fueling transaction in accordance with an example embodiment of the present disclosure.

At operation 702, the user 406 may initiate a fueling transaction using the application installed on the computing device 110. The user 406 may provide at least one input including the selected fueling station, the pump number, and optionally enterprise-specific prompts such as odometer reading, vehicle number, or job code. The at least one input may be captured and structured as a fueling request.

At operation 704, the computing device 110 may transmit the fueling request to the at least one processor 200. The at least one processor 200 may receive and parse the fueling request and may generate a unique transaction code that may map to the requested fueling session.

At operation 706, the at least one processor 200 may receive and may display the generated the unique transaction code to the user 406. The unique transaction code may be used to link the fueling request to the corresponding fuel dispensing unit 106 at the fueling station.

At operation 708, the user 406 may enter the unique transaction code into a keypad of the fuel dispensing unit 106. The unique transaction code may establish an association between the fuel dispensing unit 106 and the authorization session.

At operation 710, the merchant point of sale system 112 may transmit the entered unique transaction code to the system 100, thereby initiating a verification sequence.

At operation 712, the at least one processor 200 may validate the unique transaction code by checking authenticity, status, time validity, and metadata consistency, including location and pump identifiers. Upon successful verification, the at least one processor 200 may send an acknowledgment back to the merchant point of sale system 112.

At operation 714, the at least one processor 200 may communicate with a transaction processor network to pre-authorize the fueling transaction. The communication may include issuing a preliminary authorization for a maximum fuel limit or monetary cap tied to the fueling request.

At operation 716, the at least one processor 200 may transmit an authorization request to the transaction processor network based on the pump number, selected fuel product, and the driver's enterprise credentials. The authorization request may include a secure token generated, ensuring that the user may be permitted to initiate fueling and that the enterprise account or associated payment method is valid for the requested transaction.

At operation 718, the transaction processor network may evaluate the authorization request and may return a pre-authorization approval to the system 100. The pre-authorization approval may correspond that “a transaction is now approved”. The pre-authorization approval may include a pre-authorized transaction limit, a transaction ID, and associated metadata required for downstream transaction reconciliation.

At operation 720, the at least one processor 200 may prompt the user to “follow directions on the pump.” The prompt may inform the user 406 that the fueling process is ready to begin and may provide guidance such as lifting the nozzle, selecting fuel grade, or initiating dispensing.

At operation 722, the at least one processor 200 may initiate an arming command for the selected fuel dispensing unit 106 by communicating with the forecourt control interface 104. The arming command may enable fuel dispensing functionality at the fuel dispensing unit 106, based on successful prior authorization of the user, fuel product selection, and token-based verification. The fuel dispensing unit 106 may now in an active, ready state to allow the user 406 to dispense fuel.

At operation 724, the user 406 may physically remove the fuel nozzle from the fuel dispensing unit 106 and may insert the fuel nozzle into the vehicle's fuel tank. At operation 726, the user 406 may begin dispensing fuel by activating the nozzle handle. Fuel may begin to flow into the vehicle's tank while the at least one processor 200 may monitor the fueling session in real time using data relayed via the forecourt control interface 104.

At operation 728, the user 406 may complete fueling and return the nozzle to its holster on the fuel dispensing unit 106. The manual action may terminate the flow of fuel.

At operation 730, the at least one processor 200 may finalize the fueling transaction by retrieving the completed transaction details from the merchant point of sale system 112. The fuel transaction may include total fuel dispensed, transaction amount, fuel type, pump number, and any loyalty discounts or taxes applied. The transaction record may be transmitted to the transaction processor network for validation and logging.

At operation 732, the at least one processor 200 may display a digital receipt to the user 406. The digital receipt may include transaction details such as time, location, amount paid, and fuel volume. In some embodiments, the digital receipt may also be sent to the user's registered email or stored in the transaction history for future reference.

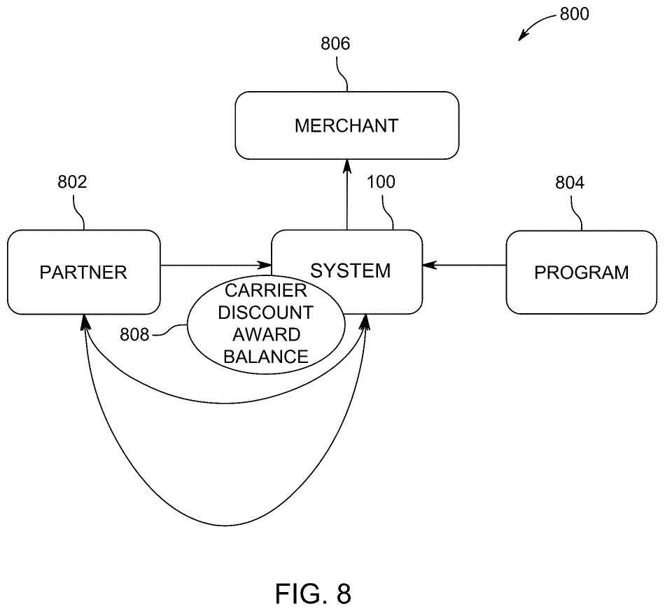

FIG. 8 illustrates an interaction diagram 800 between a partner 802, a program 804, a merchant 806, and the system 100 in accordance with an example embodiment of the present disclosure.

In some embodiments, the system 100 may be configured to receive program-related data from a program 804 from the partner 802. In one example, the partner 802 may correspond to a WERNER. In another example, the program 804 may correspond to a WERNER. The program 804 may define specific rules, thresholds, or eligibility conditions for applying carrier discount awards. The partner 802 may provide operational or transactional data related to carrier activity or eligibility.

In some embodiments, the system 100 may be configured to process the received data to generate or update a carrier discount award balance 808 corresponding to the partner 802.

The carrier discount award balance 808 may reflect incentives, credits, or discounts earned based on predefined carrier performance metrics, engagement levels, or transactional triggers.

In some embodiments, the carrier discount award balance 808 may be then used by the system 100 to facilitate transactions with a merchant 806. In one example, when the partner 802 seeks to engage in a transaction with the merchant 806, the system 100 may apply the available award balance to offset costs, apply discounts, or redeem benefits as per the configured rules from the program 804. In some embodiments, the flow of information and control logic may be bi-directional.

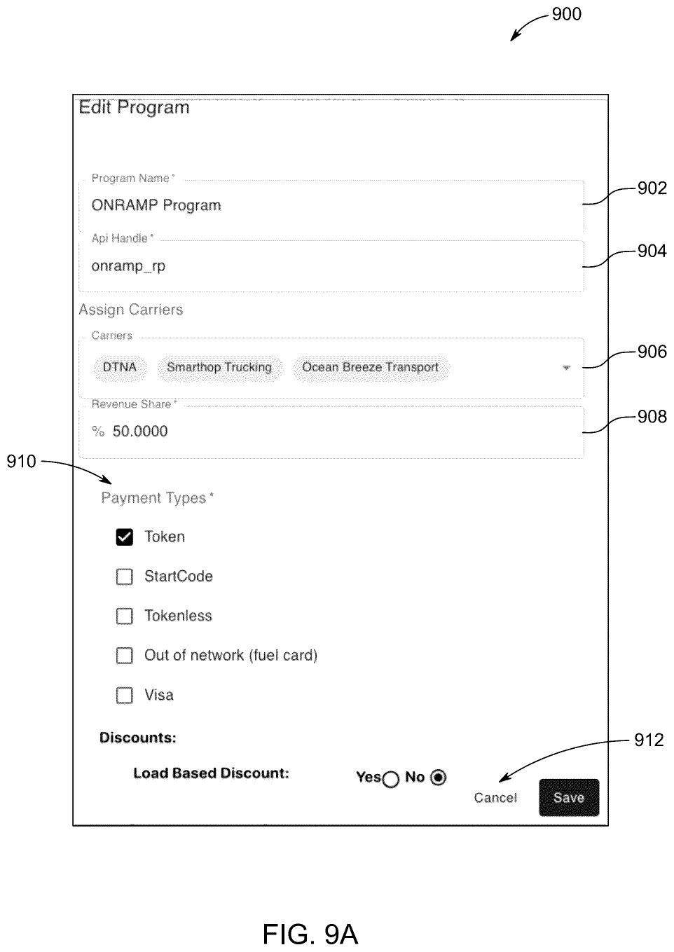

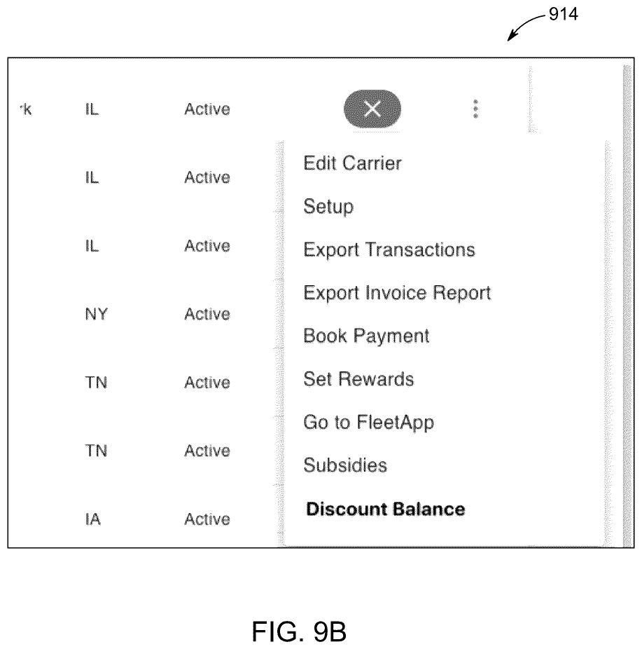

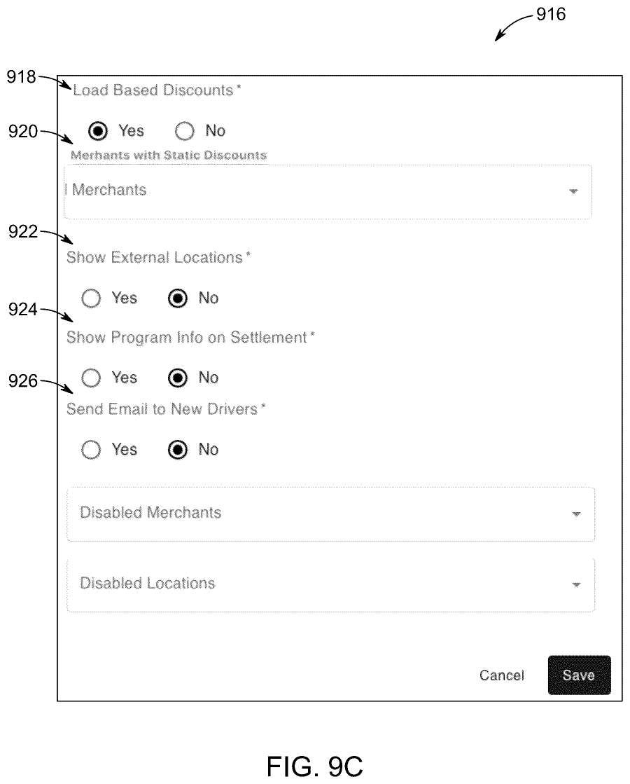

FIGS. 9A-9C illustrate example user interface (UI) screens of the fuel utilization management application 114 for configuring and managing a discount program in accordance with an example embodiment of the present disclosure.

FIG. 9A illustrates a program configuration interface 900 of the fuel utilization management application 114 that may enable administrative users to define and edit parameters of a discount program. The program configuration interface 900 may include input fields for assigning a program name 902 and an API handle 904. A carrier assignment section may enable the selection of one or more carriers (shown by 906) to participate in the program. The one or more carriers may comprise at least one of “DTNA”, “Smarthop Trucking”, and “Ocean Breeze Transport”. Further, a revenue share field (shown by 908) may allow the input of a percentage value (e.g., 50%) to allocate an earned fuel discount or savings between the carrier and the program sponsor. The program configuration interface 900 may also include a payment method section 910 that may support multiple transaction types such as Token, StartCode, Tokenless, Fuel Card (out of network), and Visa, enabling flexibility in fuel purchase mechanisms. A toggle switch (shown by 912) may be presented for enabling or disabling a load-based discount feature, where applicable discounts may be earned and consumed based on carrier fuel transactions linked to freight loads.

FIG. 9B illustrates a dropdown menu interface 914 of the fuel utilization management application 114 associated with carrier-specific program administration. Upon selecting a carrier, the dropdown menu interface 914 may enable access to a set of options including “Edit Carrier”, “Setup”, “Export Transactions”, and “Export Invoice Report” to facilitate data export and carrier configuration. Additional options such as “Book Payment”, “Set Rewards”, and “Subsidies” may allow the administrative users to manage incentive programs and payment-related actions. The option “Go to FleetApp” may redirect the administrative users to a connected fleet management application. The dropdown menu interface 914 may further include a “Discount Balance” selection. The “Discount Balance” selection may enable real-time visibility into the remaining volume of discounted gallons or credit associated with a carrier.

FIG. 9C illustrates a user interface 916 of the fuel utilization management application 114 for managing advanced parameters of a discount program, particularly those involving load-based discount handling and merchant visibility controls. The user interface 918 may include a toggle to enable or disable the decrementing of earned load-based discounts during eligible fuel purchases. When enabled, the setting may allow carriers to consume a predefined number of discounted gallons based on mileage or load performance metrics. A dropdown menu 920 may enable the administrative users to select merchants that may offer static discounts exempt from decrementing logic. The user interface 916 may also allow the enabling or disabling of program visibility at external locations (shown by 922), controlling whether non-participating merchant locations are shown to drivers. Further settings may include options to show program information on settlement statements (shown by 924) and to send email notifications to new drivers (shown by 926).

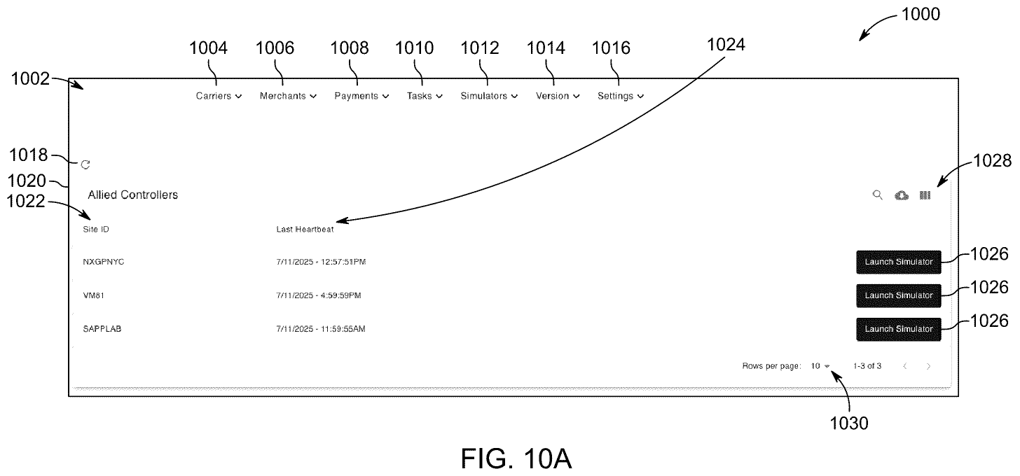

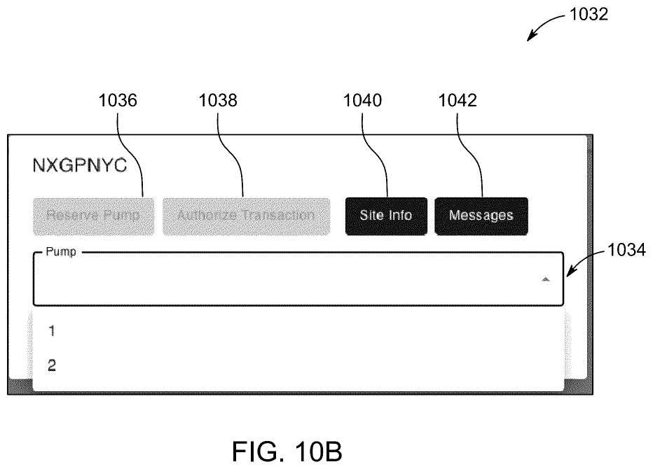

FIGS. 10A-10B illustrate exemplary user interface of a controller simulator system configured for fuel site management in accordance with example embodiments of the present disclosure.

FIG. 10A illustrates a user interface 1000 that may present a list of controllers deployed across multiple fueling sites. The user interface 1000 may be designed to allow the administrative users to monitor and manage various site controllers remotely. At the top of the user interface 1000, a navigation bar 1002 may include multiple menu options such as carriers 1004, merchants 1006, payments 1008, tasks 1010, simulators 1012, version 1014, and settings 1016, each corresponding to a functional module of the controller simulator system.

In some embodiments, beneath the navigation bar 1002, the user interface 1000 may include a refresh icon 1018 that may allow the administrative users to update the displayed controller list. A table (shown by 1020) labeled “Allied Controllers” may be shown with at least two columns. The two columns may comprise a site ID 1022 and last heartbeat 1024. The site ID 1022 may display unique identifiers for different fueling sites, such as NXGPNYC, VM81, and SAPPLAB. The last heartbeat 1024 may show timestamps indicating the last time each respective controller communicated with the system 100, confirming the active status.

In some embodiments, each entry in the table 1020 may include a “Launch Simulator” button 1026, which, when activated, may initiate a simulation environment for the corresponding site controller. The “Launch Simulator” button 1026 may be particularly useful for testing, diagnostics, or simulating site behavior without requiring physical access to the controller hardware. Further, user interface icons 1028 located near the top right corner of the controller list may allow further interaction, including a search icon for filtering site entries, a cloud upload/download icon for data exchange, and a layout toggle icon for switching between view modes. At the bottom right, pagination controls 1030 may display the number of rows per page and the current range of visible entries.

FIG. 10B shows a user interface 1032 that may be launched upon selecting a specific controller site. In one example, NXGPNYC may correspond to the specific controller site. The user interface 1032 may include a dropdown menu 1034 labeled “Pump,” which may list selectable pump numbers associated with the site controller, such as pump 1 and pump 2. The selection of the pump may be a prerequisite for further actions within the simulation flow.

In some embodiments, positioned above the pump selection dropdown menu 1034 may be multiple interface buttons including reserve pump 1036, authorize transaction 1038, site info 1040, and messages 1042. The reserve pump 1036 and the authorize transaction 1038 buttons may be initially disabled and may become active once a valid pump is selected. The multiple interface buttons may allow the user to simulate pump reservation and transaction authorization workflows. The site info 1040 may provide detailed configuration and status information about the selected controller site, while the messages 1042 may give access to system alerts or communication logs.

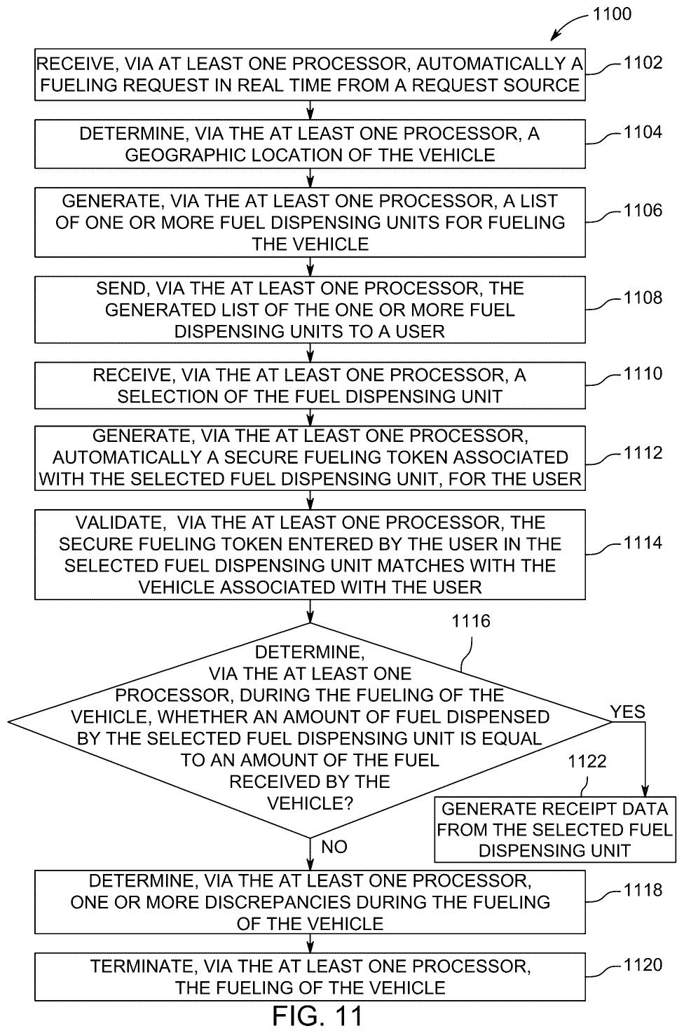

FIG. 11 illustrates a flowchart 1100 of a method for executing a transaction session in accordance with an example embodiment of the present disclosure.

At operation 1102, the at least one processor 200 receives automatically a fueling request in real time from a request source. The fueling request corresponds to a request from the request source for fueling a vehicle. In some embodiments, the request source comprises at least the vehicle associated with a company or the user responsible for paying for the fueling, a computing device associated with the user or the company, or a computing device of the vehicle. The user corresponds to an autonomous driver or a physical driver of the vehicle. The fueling request corresponds to an action initiated by the user through a mobile application or an authorized interface installed on the computing device 110. The mobile application corresponds to a fuel utilization management application 114. The fueling request includes user identification credentials. Upon receiving the fueling request, the at least one processor 200 initiates a sequence of backend processing operations that verifies the user identification credentials, and may assess eligibility for fueling.

In one example, a user operating an electric-hybrid vehicle equipped with a fuel monitoring module and onboard telematics system. When the vehicle's fuel level drops below a predefined threshold such as 15%, the vehicle's internal system automatically generates a fueling request. This request includes data such as vehicle ID, fuel level, and current time, and is transmitted to the fuel utilization management system in real time without requiring any manual input from the user. The at least one processor 200 communicatively coupled to the fuel monitoring module and onboard telematics system of the vehicle, receives this fueling request and proceeds to analyze it for further processing.

At operation 1104, the at least one processor 200 determines a geographic location of the vehicle upon receiving the fueling request from the request source. In some embodiments, the geographic location of the vehicle is determined using at least one of GPS coordinates, Wi-Fi-based location services, or cellular triangulation.

In one example, upon receiving the fueling request, the GPS module integrated in the onboard telematics system gets activated to determine real-time location of the vehicle. The GPS module returns precise coordinates corresponding to the vehicle's current position i.e., 37.7749° N, 122.4194° W, placing the vehicle in San Francisco, California. Alternatively, if the GPS signal is obstructed, such as when the vehicle is inside a parking garage in downtown San Francisco, the at least one processor may rely on Wi-Fi-based positioning or cellular triangulation to estimate the location with sufficient accuracy for identifying nearby fueling options.

At operation 1106, the at least one processor 200 generates a list of one or more fuel dispensing units for fueling the vehicle, based on at least the determined current geographic location of the vehicle. Further, the at least one processor 200 is configured to generate the list of the one or more fuel dispensing units within a predefined proximity for fueling the vehicle, based on one or more parameters associated with the user. The one or more parameters includes at least one of a transaction history, the user credentials, vehicle information, fueling preferences, or time-of-day usage patterns.

In one example, based on the previously determined GPS coordinates placing the vehicle in San Francisco, California, the at least one processor queries a backend fuel station database that includes real-time information on fuel dispensing units within a predefined radius such as 5 miles. The at least one processor 200 filters and compiles a list of nearby fuel dispensing units, including stations such as Shell at Mission Street, Chevron on Van Ness Avenue, and 76 Gas Station near Market Street. Additional parameters, such as fuel type availability (e.g., regular, premium, or diesel), current wait times, or user preferences (such as preferred fuel brands), may further refine the list. The resulting list is then prepared for presentation to the user for selection.

At operation 1108, the at least one processor 200 sends the generated list of the one or more fuel dispensing units to the user. In one example, after generating the list of the one or more fuel dispensing units near the vehicle's current location in San Francisco, California, the at least one processor transmits this list to the user's computing device 110 via the fuel utilization management application installed 114 on the computing device 110. The list is displayed within the fuel utilization management application, showing fuel stations such as Shell—Mission Street (0.8 miles), Chevron—Van Ness Avenue (1.2 miles), and 76 Gas—Market Street (1.6 miles). Each entry in the list may include additional information such as fuel prices, station ratings, operating hours, and estimated time to reach the location, enabling the user to make an informed selection.

At operation 1110, the at least one processor 200 receives a selection of the fuel dispensing unit 106 from the generated list of the one or more fuel dispensing units, from the user. The user interacts with the fuel utilization management application 114 to select the specific fuel dispensing unit 106 from the list of eligible one or more fuel dispensing units. The selection includes identifying information such as the pump number, the location ID, or the QR code corresponding to the selected fuel dispensing unit 106.

In some embodiments, the at least one processor 200 receives via the image capturing unit installed with the vehicle, one or more images of the dispensing unit captured by the image capturing unit. Further, the at least one processor 200 analyzes using the AI vision module 208, the one or more images of the fuel dispensing unit 106 to determine a unique identification number associated with the fuel dispensing unit 106. Further, the at least one processor 200 further compares the determined unique identification number with the selected fuel dispensing unit 106 to confirm the selected fuel dispensing unit 106 by the user.

In some embodiments, the at least one processor 200 may be configured to analyze data from one or more vision-based or sensor-based systems to verify the identity of the vehicle, driver, or fuel dispensing unit. In one example, the image capturing unit installed with the vehicle or at the fueling location may capture images or video of the vehicle, driver, or fuel dispensing unit. The AI vision module my process the captured images or video to determine one or more unique identifiers associated with the vehicle, driver, or fuel dispensing unit, and verify that they correspond to the selected vehicle, driver, or fuel dispensing unit. In some embodiments, the at least one processor 200 may also infer fuel level, fuel usage, or fueling behavior based on visual data or data received from an ELD associated with the vehicle. The at least one processor 200 may use such inferred information in real time to detect discrepancies, prevent fraud, or optimize fueling operations, and may integrate these determinations with other enforcement logic, including fleet-defined rules and override preferences.

In one example, upon reviewing the list of nearby fueling stations displayed on the fuel utilization management application 114 on their smartphone, the user selects the Chevron station on Van Ness Avenue based on a combination of shorter wait time and competitive fuel pricing. The application captures the user's selection and transmits it back to the fuel utilization management system over a secure network. The selected fuel dispensing unit 106 is then associated with the user session for further operations such as token generation and validation.

At operation 1112, the at least one processor 200 generates automatically the secure fueling token associated with the selected fuel dispensing unit, for the user. The secure fueling token is digitally linked to the fuel dispensing unit 106 that the user has selected. The secure fueling token acts like a temporary, unique permission slip that may allow the selected fuel dispensing unit 106 to be activated for fueling. The secure fueling token is a time-bound, cryptographically generated identifier that may uniquely link a user session to the selected fuel dispensing unit 106. The secure fueling token includes encoded metadata such as user ID, dispenser ID, fuel product selection, authorization parameters, and token expiration time. The secure fueling token serves as a digital key to enable fuel delivery and prevent unauthorized access or spoofing attempts

In one example, after receiving the user's selection of the Chevron station on Van Ness Avenue in San Francisco, the at least one processor 200 automatically generates a secure fueling token uniquely linked to both the selected fuel dispensing unit 106 and the user's vehicle. The secure fueling token may include encrypted data such as the user ID, vehicle ID, timestamp, fuel station ID, fuel dispenser number, and a digital signature to prevent tampering. The secure fueling token is created using cryptographic techniques (e.g., asymmetric encryption or hash-based message authentication) and is time-limited to ensure it is valid only within a short time window, such as 15 minutes.

At operation 1114, the at least one processor 200 validates the secure fueling token entered by the user in the selected fuel dispensing unit 106 matches with the vehicle associated with the user, for fueling of the vehicle. The at least one processor 200 also checks if the secure fueling token entered at the selected fuel dispensing unit 106 is valid. The at least one processor 200 confirms that the secure fueling token matches the vehicle associated with the user. If the secure fueling token and the vehicle match, the fueling operation for that vehicle is allowed to proceed.

In some embodiments, the at least one processor 200 transmits using the secure communication link, the secure fueling token entered by the user to the forecourt control interface 104 to validate the secure fueling token. The secure communication link utilizes encrypted protocols such as Transport Layer Security to prevent interception or tampering of the secure fueling token during transmission. The forecourt control interface 104 then decodes or verify the secure fueling token, validate integrity and authorization, and activates the fuel dispensing unit 106.

In one example, when the user arrives at the Chevron station on Van Ness Avenue, the user approaches the assigned fuel dispenser and enters or scan the previously generated secure fueling token using a QR code reader, keypad, or NFC interface on the dispenser. The secure fueling token is transmitted to the forecourt control interface linked to the fuel utilization management system. The at least one processor 200 then verifies the token by checking its authenticity, expiration time, and whether it matches the stored credentials for the specific user and vehicle such as the vehicle identification number (VIN) or user ID. Upon successful validation, the at least one processor 200 confirms that the correct vehicle is present at the correct dispenser and authorizes the initiation of the fueling process.

At operation 1116, the at least one processor 200 determines during the fueling of the vehicle, whether an amount of fuel dispensed by the selected fuel dispensing unit 106 is equal to an amount of the fuel received by the vehicle, based at least on a plurality of parameters associated with the selected fuel dispensing unit and a plurality of parameters associated with the vehicle. The plurality of parameters associated with the selected fuel dispensing unit comprises at least type of fuel dispensed, the amount of fuel dispensed, price of the fuel, and rate of the fuel. Further, the plurality of parameters associated with the vehicle comprises at least fuel type of vehicle, real time fuel level within a fuel tank of the vehicle, and capacity of the fuel tank of the vehicle.

In some embodiments, the plurality of parameters associated with the selected fuel dispensing unit comprises at least type of fuel dispensed, the amount of fuel dispensed, price of the fuel, and rate of the fuel. In some embodiments, the plurality of parameters associated with the vehicle comprises at least fuel type of vehicle, real time fuel level within a fuel tank of the vehicle, and capacity of the fuel tank of the vehicle.

In one example, as the user's vehicle is being fueled at the Chevron station, the at least one processor collects real-time data from both the fuel dispensing unit and the vehicle's onboard telematics system. From the fuel dispenser, the at least one processor receives data such as, fuel type dispensed (e.g., Premium Gasoline), total volume dispensed (e.g., 11.4 gallons), fuel price per gallon, and dispensing rate. Simultaneously, the vehicle onboard telematics system reports parameters including, vehicle-compatible fuel type (e.g., Premium Gasoline), initial fuel level (e.g., 2.6 gallons), final fuel level (e.g., 14.0 gallons), and maximum tank capacity (e.g., 15 gallons). The at least one processor compares the dispensed amount (11.4 gallons) with the difference in vehicle fuel level (14.0-2.6=11.4 gallons). Since the values match and the fuel types are compatible, the at least one processor determines that the fueling process is consistent and accurate.

In another example, the vehicle onboard telematics system reports parameters including, vehicle-compatible fuel type (e.g., Premium Gasoline), initial fuel level (e.g., 2.6 gallons), final fuel level (e.g., 13.6 gallons), and maximum tank capacity (e.g., 15 gallons). The at least one processor compares the dispensed amount (11.4 gallons) with the difference in vehicle fuel level (13.6−2.6=11 gallons). Since the values does not match and the fuel types are compatible, the at least one processor 200 determines that the fueling process is not consistent and accurate.

If the amount of fuel dispensed by the selected fuel dispensing unit 106 is not equal to an amount of the fuel received by the vehicle, the at least one processor directs to operation 1118. At operation 1118, the at least one processor 200 determines one or more discrepancies during the fueling of the vehicle upon determining the amount of fuel dispensed by the selected fuel dispensing unit is not equal to the amount of the fuel received by the vehicle. The plurality of parameters associated with the selected fuel dispensing unit comprises at least type of fuel dispensed, the amount of fuel dispensed, price of the fuel, and rate of the fuel. Further, the plurality of parameters associated with the vehicle comprises at least fuel type of vehicle, real time fuel level within a fuel tank of the vehicle, and capacity of the fuel tank of the vehicle.

In one example, while fueling continues at the Chevron station on Van Ness Avenue, the fuel dispensing unit reports that 11.4 gallons of regular gasoline have been dispensed.

However, based on real-time data from the vehicle's onboard telematics system detects that the vehicle's fuel level has received 11 gallons and the tank's full capacity has not been reached.

This mismatch indicates a discrepancy of 0.5 gallons. Upon detecting this variance, the at least one processor flags it as a potential issue, such as fuel leakage, miscalibration of the dispenser, or possible fuel theft. As a result, the at least one processor immediately triggers a feedback alert on the user's computing device and dashboard interface, stating: “Discrepancy detected: Fuel dispensed does not match fuel received. Please check vehicle and contact support if issue persists.”

At operation 1120, the at least one processor 200 terminates the fueling of the vehicle upon determining the one or more discrepancies. In some embodiments, the at least one processor 200 further triggers a feedback alert to the user upon determining the one or more discrepancies.

If the amount of fuel dispensed by the selected fuel dispensing unit 106 is equal to an amount of the fuel received by the vehicle, the at least one processor directs to operation 1122.

At operation 1122, the at least one processor 200 generates the receipt data from the selected fuel dispensing unit, upon determining the amount of fuel dispensed by the selected fuel dispensing unit 106 is equal to the amount of the fuel received by the associated vehicle.

Further, at least one processor 200 transmits the receipt data to the computing device 110 to initiate digital payment, upon fueling of the vehicle. In some embodiments, the receipt data includes at least one of the quantity of fuel dispensed, total transaction cost, time of fueling, and identifier of the fuel dispensing unit.

The present disclosure offers several notable advantages. The system 100 enables a secure and efficient fueling experience by shifting a driver-facing interface from the fuel dispensing unit 106 to a mobile application, while maintaining compatibility with existing merchant infrastructure through the forecourt control interface 104. The system 100 allows the user to select the pump number and the one or more fuel products, and to respond to one or more prompts directly via the mobile application, thereby minimizing physical interaction with the point-of-sale system. By utilizing token-based communication between the MPPA, the mobile application, and the forecourt control interface 104, the system 100 ensures secure transaction initiation, accurate relay of prompt values, and effective validation of user input.

Overall, the system 100 provides a scalable, backward-compatible, and automation-ready solution for modernizing commercial fuel dispensing workflows.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A fuel utilization management system comprising:
a memory having one or more computer readable instructions;
at least one processor communicatively coupled with the memory, wherein the at least one processor executing the one or more computer readable instructions stored in the memory is configured to:
receive, from a request source, automatically a fueling request in real time, wherein the fueling request corresponds to a request from the request source for fueling a vehicle;
determine a geographic location of the vehicle upon receiving the fueling request from the request source;
generate a list of one or more fuel dispensing units for fueling the vehicle, based at least on the determined geographic location of the vehicle;
send the generated list of the one or more fuel dispensing units to a user;
receive a selection of a fuel dispensing unit from the generated list of the one or more fuel dispensing units, from the user;
generate automatically a secure fueling token associated with the selected fuel dispensing unit, for the user;
validate the secure fueling token entered by the user in the selected fuel dispensing unit matches with the vehicle associated with the user, for fueling of the vehicle;
determine, during the fueling of the vehicle, whether an amount of fuel dispensed by the selected fuel dispensing unit is equal to an amount of the fuel received by the vehicle, based at least on a plurality of parameters associated with the selected fuel dispensing unit and a plurality of parameters associated with the vehicle;
determine one or more discrepancies during the fueling of the vehicle upon determining the amount of fuel dispensed by the selected fuel dispensing unit is not equal to the amount of the fuel received by the vehicle; and
terminate the fueling of the vehicle upon determining the one or more discrepancies.

2. The fuel utilization management system of claim 1, wherein the at least one processor executing the one or more computer readable instructions stored in the memory is further configured to:
a. monitor fuel flow rate from the fuel dispensing unit in real time;
b. compare the monitored rate with expected parameters derived from vehicle sensor data, ELD data, or video analysis; and
c. issue control signals to pause, resume, or terminate fuel dispensing via the forecourt controller or POS system.

3. The fuel utilization management system of claim 1, wherein the request source comprises at least the vehicle associated with a company or the user responsible for paying for the fueling, a computing device associated with the user or the company, or a computing device of the vehicle.

4. The fuel utilization management system of claim 3, wherein at least one processor executing the one or more computer readable instructions stored in the memory is configured to:
dynamically repricing a unit price of fuel upon receiving the fueling request from the request source, based at least on a current retail price, a negotiated agreement between a fuel carrier and a merchant, a negotiated agreement between a fuel program and the merchant, a negotiated agreement between the carrier and the fuel program, or a schedule of fees;
generate in real time, receipt data from the selected fuel dispensing unit based at least on the repricing of the unit price and upon determining the amount of fuel dispensed by the selected fuel dispensing unit is equal to the amount of the fuel received by the vehicle; and
transmit the receipt data to the computing device to initiate digital payment, upon fueling of the vehicle.

5. The fuel utilization management system of claim 1, wherein the at least one processor executing the one or more computer readable instructions stored in the memory is further configured to:
a. enforce fueling authorization policies dynamically based on rules specified by a fleet operator, the rules including at least risk tolerance thresholds, vehicle-specific fuel capacity limits, driver identity requirements, and override conditions;
b. adapt the fraud detection and enforcement logic in real time based on the specified fleet rules, including pausing, limiting, or terminating fueling transactions; and
c. selectively enable fleet-authorized overrides to resume fueling after a transaction has been paused or terminated due to policy enforcement.

6. The fuel utilization management system of claim 4, wherein at least one processor executing the one or more computer readable instructions stored in the memory is configured to:
prior to determine the current geographic location of the vehicle and generate the secure fueling token, validate that the fueling request is not fraudulent, based on historical information of the request source, wherein the historical information includes at least purchase history and location history; and
preauthorize a purchasing power of the secure fueling token, based on the historical information, business rules specified by the user associated with the vehicle, and business rules specified by the fuel program.

7. The fuel utilization management system of claim 2, wherein at least one processor executing the one or more computer readable instructions stored in the memory is configured to:
transmit the secure fueling token directly to at least one of:
a point-of-sale (POS) system associated with the selected fuel dispensing unit, or
a forecourt control interface associated with the selected fuel dispensing unit, for enabling fueling of the vehicle automatically;
inject the secure fueling token into at least one of the POS system or the forecourt control interface, associated with the selected fuel dispensing unit, in response to determining that the selected fuel dispensing unit does not have a direct integration with the fuel utilization management system; and
activate the selected fuel dispensing unit via at least one of the POS interface or the forecourt control interface, without generating the secure fueling token, to enable tokenless fueling of the vehicle.

8. The fuel utilization management system of claim 7, wherein the at least one processor executing the one or more computer readable instructions stored in the memory is configured to transmit, using a secure communication link, the secure fueling token entered by the user to the forecourt control interface to validate the secure fueling token.

9. The fuel utilization management system of claim 1, wherein the plurality of parameters associated with the selected fuel dispensing unit comprises at least type of fuel dispensed, the amount of fuel dispensed, price of the fuel, and rate of the fuel, and wherein the plurality of parameters associated with the vehicle comprises at least fuel type of vehicle, real time fuel level within a fuel tank of the vehicle, and capacity of the fuel tank of the vehicle.

10. The fuel utilization management system of claim 1, wherein the at least one processor executing the one or more computer readable instructions stored in the memory is further configured to:
a. identify the vehicle, driver, or fuel dispensing unit based on at least one of: video imagery from a camera located at the fueling site, sensor data from the vehicle, or sensor data from the fueling equipment;
b. apply artificial intelligence or machine learning algorithms to verify that the identified vehicle or driver matches the fueling request;
c. determine, based on at least video imagery, telematics data, or electronic logging device (ELD) data, whether the amount of fuel dispensed is consistent with expected consumption of the identified vehicle; and
d. automatically terminate or pause fueling upon determining a mismatch or suspected fraudulent fueling activity.

11. The fuel utilization management system of claim 2, wherein the at least one processor executing the one or more computer readable instructions stored in the memory is further configured to:
receive, via an image capturing unit installed within the vehicle, one or more images of the selected fuel dispensing unit captured by the image capturing unit;
analyze, using an artificial intelligence (AI) vision module, the one or more images of the selected fuel dispensing unit to determine a unique identification number associated with the selected fuel dispensing unit; and
compare the determined unique identification number with the selected fuel dispensing unit to confirm the selected fuel dispensing unit by the user.

12. The fuel utilization management system of claim 1, wherein the at least one processor executing the one or more computer readable instructions stored in the memory is further configured to trigger a feedback alert to the user upon determining the one or more discrepancies, wherein the one or more discrepancies comprises the vehicle moving away from the selected fuel dispensing unit determined based on the geographic location of the vehicle.

13. The fuel utilization management system of claim 11, wherein the receipt data includes at least one of a quantity of fuel dispensed, total transaction cost, time of fueling, and the a unique identification number associated with the selected fuel dispensing unit, and discount price of the fuel provided to the request source.

14. The fuel utilization management system of claim 1, wherein the geographic location of the vehicle is determined using at least one of GPS coordinates, Wi-Fi-based location services, or cellular triangulation.

15. A method comprising:
receiving, via at least one processor executing one or more computer readable instructions stored in a memory of a fuel utilization management system, automatically a fueling request in real time from a request source, wherein the fueling request corresponds to a request from the request source for fueling a vehicle;
determining, via the at least one processor, a geographic location of the vehicle upon receiving the fueling request from the request source;
generating, via the at least one processor, a list of one or more fuel dispensing units for fueling the vehicle, based on at least the determined geographic location of the vehicle;
sending, via the at least one processor, the generated list of the one or more fuel dispensing units to a user;
receiving, via the at least one processor, a selection of a fuel dispensing unit from the generated list of the one or more fuel dispensing units, from the user;
generating, via the at least one processor, automatically a secure fueling token associated with the selected fuel dispensing unit, for the user;
validating, via the at least one processor, the secure fueling token entered by the user in the selected fuel dispensing unit matches with the vehicle associated with the user, for fueling of the vehicle;
determining, via the at least one processor, during the fueling of the vehicle, whether an amount of fuel dispensed by the selected fuel dispensing unit is equal to an amount of the fuel received by the vehicle, based at least on a plurality of parameters associated with the selected fuel dispensing unit and a plurality of parameters associated with the vehicle;
determining, via the at least one processor, one or more discrepancies during the fueling of the vehicle upon determining the amount of fuel dispensed by the selected fuel dispensing unit is not equal to the amount of the fuel received by the vehicle; and
terminating, via the at least one processor, the fueling of the vehicle upon determining the one or more discrepancies.

16. The method of claim 15, wherein the request source comprises at least the vehicle associated with a company or the user responsible for paying for the fueling, a computing device associated with the user or the company, or a computing device of the vehicle.

17. The method of claim 16, further comprising:
dynamically repricing, via the at least one processor, a unit price of fuel upon receiving the fueling request from the request source, based at least on a current retail price, a negotiated agreement between a fuel carrier and a merchant, a negotiated agreement between a fuel program and the merchant, a negotiated agreement between the carrier and the fuel program, or a schedule of fees;
generating, via the at least one processor, in real time, receipt data from the selected fuel dispensing unit based at least on the repricing of the unit price and upon determining the amount of fuel dispensed by the selected fuel dispensing unit is equal to the amount of the fuel received by the vehicle; and
transmitting, via the at least one processor, the receipt data to the computing device to initiate digital payment, upon fueling of the vehicle.

18. The method of claim 17, further comprising:
prior to determine the current geographic location of the vehicle and generate the secure fueling token, validating, via the at least one processor, that the fueling request is not fraudulent, based on historical information of the request source, wherein the historical information includes at least purchase history and location history; and
preauthorizing, via the at least one processor, a purchasing power of the secure fueling token, based on the historical information, business rules specified by the user associated with the vehicle, and business rules specified by the fuel program.

19. The method of claim 16, further comprising:
transmitting, via the at least one processor, the secure fueling token directly to at least one of:
a point-of-sale (POS) system associated with the selected fuel dispensing unit, or
a forecourt control interface associated with the selected fuel dispensing unit, for enabling fueling of the vehicle automatically;
injecting, via the at least one processor, the secure fueling token into at least one of the POS system or the forecourt control interface, associated with the selected fuel dispensing unit, in response to determining that the selected fuel dispensing unit does not have a direct integration with the fuel utilization management system; and
activating, via the at least one processor, the selected fuel dispensing unit via at least one of the POS interface or the forecourt control interface, without generating the secure fueling token, to enable tokenless fueling of the vehicle.

20. The method of claim 19, further comprising transmitting, via the at least one processor, the secure fueling token entered by the user to the forecourt control interface to validate the secure fueling token using a secure communication link.

21. The method of claim 15, wherein the plurality of parameters associated with the selected fuel dispensing unit comprises at least type of fuel dispensed, the amount of fuel dispensed, price of the fuel, and rate of the fuel, and wherein the plurality of parameters associated with the vehicle comprises at least fuel type of vehicle, real time fuel level within a fuel tank of the vehicle, and capacity of the fuel tank of the vehicle.

22. The method of claim 16, further comprising:
receiving, via the at least one processor, the one or more images of the selected fuel dispensing unit captured by an image capturing unit installed within the vehicle;
analyzing, via the at least one processor, the one or more images of the selected fuel dispensing unit to determine a unique identification number associated with the selected fuel dispensing unit, using an artificial intelligence (AI) vision module; and
comparing, via the at least one processor, the determined unique identification number with the selected fuel dispensing unit to confirm the selected fuel dispensing unit by the user.

23. The method of claim 15, further comprising triggering, via the at least one processor, a feedback alert to the user upon determining the one or more discrepancies, wherein the one or more discrepancies comprises the vehicle moving away from the selected fuel dispensing unit determined based on the geographic location of the vehicle.
